(19) United States
(12) Patent Application Publication
(10) Pub. No.: US 2006/0063587 A1
(43) Pub. Date: Mar. 23, 2006

(54) Gaming advertisement systems and methods

(76) Inventor: Anthony V. Manzo, Lake Forest, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/224,476

(22) Filed: Sep. 12, 2005

Related U.S. Application Data
(60) Provisional application No. 60/609,620, filed on Sep. 13, 2004.

(51) Int. Cl. A63F 13/00

(52) U.S. Cl. 463/25; 463/29

(57) ABSTRACT

System and method for advertising in which online and land-based gaming can be recast as new age media and product sales outlets. Such an advertising system can include a processor, a player interface, a database, and a game and reward control. Such a system can be based on player permission, targeted marketing, and/or innovations in games. Such a system can also employ features such as prize pre-selection, portable wish-lists, advertising-influenced games, reinforcement routines, and reward fulfillment. Such advertising is expected to heighten entertainment value, increase player loyalty, broaden demographics of participation, and increase profitability to those who participate. In one embodiment, such a system can include advertiser-subsidized “win-no-lose” gaming that does not require gambling, yet pays off in prizes and deep discounts. Accordingly, such advertiser-subsidized games can be located in non-gambling zones such as local bars, health clubs and airports.

### RELATED APPLICATIONS

This application claims the benefit of U.S. Provisional Application No. 60/609,620, filed on Sep. 13, 2004, entitled “WIN-WIN-WIN (WWW) GAMEADS SYSTEMS & SOFTWARE,” which is hereby incorporated herein by reference in its entirety.

### BACKGROUND

1. Field

The present disclosure generally relates to electronic gaming, and in particular, to advertising on electronic gaming devices.

2. Description of the Related Art

Electronic gaming has gained tremendous popularity in recent times. Powerful and relatively inexpensive computing and related devices provide spectacular audio-visual effects that enhance the gaming experience. Some of these gaming devices can be configured for gambling games such as video poker, video blackjack, video slot machine, and the like. Some of these gaming devices can also be configured for non-gambling games such as arcade video games.

With the popularity of affordable and fast internet access, remote electronic gaming is also very popular. Again, remote games can be gambling or non-gambling based.

Generally, players that participate in various types of electronic gaming do so because they want to. Consequently, electronic gaming players usually have great interest in different aspects of the games being played.

### SUMMARY

Various embodiments of the present disclosure address systems and methods for advertising in electronic gaming settings. Various advertising techniques can be incorporated into electronic games. The electronic games can be gambling based or non-gambling based. A given electronic gaming system can include components such as processor, player interface, database, game control, reward control, and advertisement control that facilitate various advertising techniques including player-permission-based advertising, advertisement placement, game-based advertising, targeted advertising, reinforcing advertising, positive-image advertising, feedback on effectiveness of advertising, and third-party involvement. Electronic games that incorporate one or more of these unique advertising features can enhance the gaming experience and the effectiveness of advertising.

One embodiment of the present disclosure relates to a method for increasing odds of awarding prizes. The method includes providing an electronic gaming apparatus configured to award a prize to a user according to a paytable. The method further includes accessing user preference data to determine whether the user prefers to view advertising. The method further includes displaying an advertisement on the electronic gaming apparatus in response to determination that the user prefers to view advertising. The method further includes adjusting the paytable so as to increase the odds of awarding the prize to the user in response to determination that the user prefers to view advertising.

In one embodiment, the electronic gaming apparatus includes electronic playing cards. In one embodiment, the advertisement is displayed on the electronic playing cards.

In one embodiment, the electronic gaming apparatus includes an online video game.

In one embodiment, accessing user preference data includes providing a prompt to the user to decide whether or not to view advertising. In one embodiment, the prompt for the user preference is provided at the beginning of a gaming session. In one embodiment, the prompt for the user preference is provided to the user during the gaming session.

In one embodiment, the content of the advertisement is at least in part determined by a gaming situation encountered by the user.

In one embodiment, the method further includes displaying targeted advertisements based on information about the user or the gaming apparatus. In one embodiment, the information comprises consumer interests of the user. In one embodiment, the information comprises location of the gaming apparatus.

In one embodiment, the method further includes providing reinforcing information to the user about an entity that sponsors the advertisement.

In one embodiment, the method further includes providing a message to the user to reduce the likelihood that the user will have a negative impression about the advertisement.

In one embodiment, the method further includes prompting the user for a feedback on the user's impression of the advertisement.

In one embodiment, the prize includes a coupon, a token, a discount, or a voucher for a product or service displayed in the advertisement.

In one embodiment, accessing user preference data includes accessing data on a membership card of the user.

In one embodiment, the electronic gaming apparatus includes a sensor configured to detect information contained in a detectable component in one or more physical playing cards used in live gaming. The displaying the advertisement is based on the detected information. In one embodiment, the detectable component includes a barcode imprinted on one or more of the physical playing cards. In one embodiment, the detectable component includes an RFID tag embedded in one or more of the physical playing cards.

In one embodiment, the method further includes providing a reward or incentive for viewing of the advertisement. In one embodiment, the reward or incentive is fulfilled by a third party.

In one embodiment, the method further includes receiving a wager from the user for a chance to win the prize.

In one embodiment, at least some of the prize is provided by a sponsor of the advertisement. In one embodiment, substantially all of the prize is provided by the sponsor. In one embodiment, the prize is provided from an advertising revenue provided by the sponsor.

Another embodiment of the present disclosure relates to a system for advertising. The system includes an electronic gaming apparatus configured so as to award a prize to a user according to a paytable. The system further includes an interface component configured so as to access user preference data to determine whether the user prefers to view advertising. The system further includes a display component configured so as to allow viewing of an advertisement in response to determination that the user prefers to view advertising. The system further includes a processor configured so as to adjust the paytable so as to increase the odds of awarding the prize to the user in response to determination that the user prefers to view advertising.

In one embodiment, the electronic gaming apparatus includes electronic playing cards. In one embodiment, the advertisement is displayed on the electronic playing cards.

In one embodiment, the electronic gaming apparatus includes an online video game.

In one embodiment, the interface component accesses the user preference data by providing a prompt to the user to decide whether or not to view advertising. In one embodiment, the prompt for the user preference is provided at the beginning of a gaming session. In one embodiment, the prompt for the user preference is provided to the user during the gaming session.

In one embodiment, the content of the advertisement is at least in part determined by a gaming situation encountered by the user.

In one embodiment, the advertisement includes a targeted advertisement that is based on information about the user or the gaming apparatus. In one embodiment, the information includes consumer interests of the user. In one embodiment, the information includes location of the gaming apparatus.

In one embodiment, the advertisement includes reinforcing information provided to the user about an entity that sponsors the advertisement.

In one embodiment, the advertisement includes a message provided to the user so as to reduce the likelihood that the user will have a negative impression about the advertisement.

In one embodiment, the advertisement includes a feedback component configured to obtain the user's impression of the advertisement.

In one embodiment, the prize includes a coupon, a token, a discount, or a voucher for a product or service displayed in the advertisement.

In one embodiment, the user preference data includes data on a membership card of the user.

In one embodiment, the electronic gaming apparatus includes a sensor configured to detect information contained in a detectable component in one or more physical playing cards used in live gaming. The displaying the advertisement is based on the detected information. In one embodiment, the detectable component includes a barcode imprinted on one or more of the physical playing cards. In one embodiment, the detectable component includes an RFID tag embedded in one or more of the physical playing cards.

In one embodiment, the system further includes a reward or incentive provided to the user for viewing of the advertisement. In one embodiment, the system further includes a third party that fulfills the reward or incentive.

In one embodiment, the system further includes a wager receiving component configured to receive a wager from the user for a chance to win the prize.

In one embodiment, at least some of the prize is provided by a sponsor of the advertisement. In one embodiment, substantially all of the prize is provided by the sponsor. In one embodiment, the prize is provided from an advertising revenue provided by the sponsor.

### BRIEF DESCRIPTION OF THE DRAWINGS

FIG. 1 shows a block diagram of one embodiment of a gaming system having an advertisement component;

FIG. 2 shows a block diagram of an example of a player interface component that can be part of the gaming system of FIG. 1;

FIG. 3 shows a block diagram of another example of the player interface component that can be part of the gaming system of FIG. 1;

FIG. 4 shows one embodiment of a process that can be implemented by the gaming system so that advertisement to a player can be based on the player's permission or preference;

FIG. 5 shows example messages and options that can be presented to the player during the process of FIG. 4;

FIG. 6 shows that in one embodiment, the player's preference of viewing advertisements can be changed at different times during a gaming session;

FIG. 7 shows example messages and options that can be presented to the player during the process of FIG. 6;

FIG. 8 shows that in one embodiment, advertisements can be presented on a portion of a display component such as a video screen;

FIG. 9 shows that in one embodiment, advertisements can be presented on backs of cards for electronic card games;

FIG. 10 shows that in one embodiment, advertisements can be presented on front faces of cards for electronic card games;

FIG. 11 shows an example of the gaming system configured for a gaming based advertisement where an advertisement incorporates a gaming situation encountered by the player;

FIG. 12 shows another example of the gaming based advertisement where an advertisement incorporates a gaming situation encountered by the player;

FIG. 13 shows a block diagram of one embodiment of the gaming based advertisement that can be implemented by the gaming system;

FIG. 14 shows one embodiment of a gaming based advertising process that can be performed by the gaming system of FIG. 13;

FIG. 15 shows a more specific example of the gaming based advertising process of FIG. 14;

FIG. 16 shows a block diagram of one embodiment of the gaming system configured for targeted advertising based on information about the player;

FIG. 17 shows one embodiment of a targeted advertising process that can be performed by the gaming system of FIG. 16;

FIG. 18 shows a block diagram of one embodiment of the gaming system configured for targeted advertising based on information about gaming location;

FIG. 19 shows one embodiment of a targeted advertising process that can be performed by the gaming system of FIG. 18;

FIG. 20 shows one embodiment of a process that can be performed by the gaming system, where reinforcing information about the advertiser is provided to the player with or without advertising;

FIG. 21 shows an example reinforcing message that can be provided to the player who elected not to view advertisements;

FIG. 22 shows example reinforcing messages that can be provided to the player who elected to view advertisements;

FIG. 23 shows one embodiment of a process that can be performed by the gaming system, where messages are provided to the player so as to reduce the likelihood of a negative feeling of the player towards the advertiser;

FIG. 24 shows an example message that can be provided to the player who has lost;

FIG. 25 shows an example message that can be provided to the player who has won;

FIG. 26 shows one embodiment of a process that can be performed by the gaming system to obtain gaming and/or advertisement experience feedback from the player;

FIG. 27 shows an example message that can be provided to the player who does not wish to provide feedback;

FIG. 28 shows an example message that can be provided to the player who is willing to provide feedback;

FIG. 29 shows a block diagram of one embodiment of an interaction between a sponsor of the advertisement and the player;

FIG. 30 shows a block diagram of one embodiment of an interaction between the sponsor, player, and a third party;

FIG. 31 shows that in one embodiment, the gaming system of FIG. 1 can be implemented in non-gambling games;

FIG. 32 shows a block diagram of an example of the player interface component that can be part of the non-gambling gaming system of FIG. 29;

FIG. 33 shows a block diagram of another example of the player interface component that can be part of the non-gambling gaming system of FIG. 29;

FIG. 34 shows that in one embodiment, various features of gaming based advertising can also be implemented in live gaming situations;

FIGS. 35A-35D show examples of physical gaming items, such as playing cards, having a detectable component with information that can facilitate the gaming based advertising system of FIG. 34;

FIGS. 36A and 36B show examples of the detectable component of FIGS. 35A-35D; and

FIG. 37 shows an example of a live gaming situation configured to allow gaming based advertising.

These and other embodiments, advantages, and novel features of the present disclosure will become apparent upon reading the following detailed description and upon reference to the accompanying drawings. In the drawings, similar elements have similar reference numerals.

### DETAILED DESCRIPTION OF SOME EMBODIMENTS

The present disclosure generally relates to an electronic gaming system having an advertising component. As described herein, the gaming system can be configured in a number of ways so as to make advertisements that are facilitated by the advertisement component effective.

FIG. 1 shows a block diagram of one embodiment of a gaming system 100 having a processor 102 that controls one or more features of the system 100. In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

As further shown in FIG. 1, a player interface component 104 can be controlled by the processor 102. The player interface component 104 can vary according to the type of games, and some examples of such games are described below in greater detail. For the purpose of description, “player” and “user” may be used interchangeably.

As further shown in FIG. 1, the gaming system 100 can also include a database 106 that stores information related to gaming and/or advertising. Some examples of such information are also described below in greater detail.

As further shown in FIG. 1, the gaming system 100 can also include a gaming component 108 that facilitates the operation of the game(s) being played. In one embodiment, as described below in greater detail, at least some functional feature of the gaming component 108 can be linked to the advertising functionality of the gaming system 100.

As further shown in FIG. 1, the gaming system 100 can also include a reward/paytable component 110 that facilitates rewarding or payout when the player wins. In one embodiment, as described below in greater detail, at least some functional feature of the reward component 110 can be linked to the advertising functionality of the gaming system 100.

As further shown in FIG. 1, the gaming system 100 can also include an advertisement component 112 that facilitates one or more advertising features as described herein. As described below in greater detail, various functionalities of the advertisement component 112 can be implemented in non-gambling gaming settings. Thus, although much of the various examples are described in the context of gambling games, it will be understood that the various advertising features can also be applicable to the non-gambling games.

It will also be understood that the functionalities of the processor 102, gaming, reward, advertisement components 108, 110, 112, or any combination thereof can be facilitated by one or more devices such as one or more electronic chips. That is, although the various components are depicted as separate functional block, it does not necessarily mean that such functionalities are provided by separate devices.

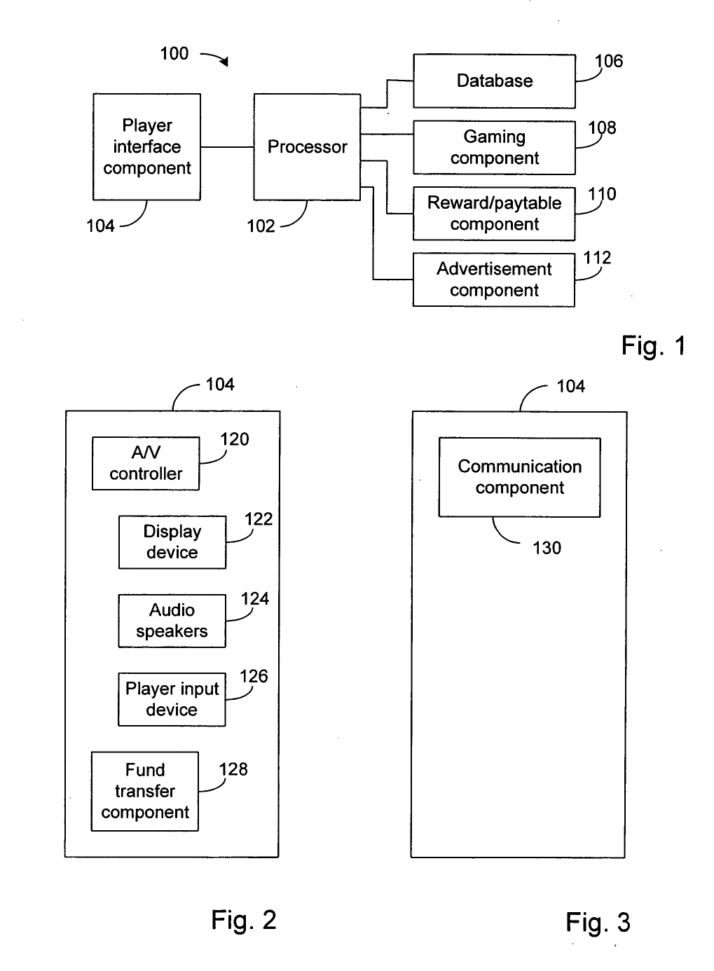

FIGS. 2 and 3 show that the player interface component 104 of the gaming system 100 can be configured in different ways. For example, in electronic casino games such as video poker or video blackjack, the player interface component 104 may include an audio-visual controller 120 that controls a display device 122 (video screen, for example), one or more audio speakers 124, and a device 126 (touch screen, for example) that allows inputs from the player. The player interface component 104 may also include a fund-transfer component 128 that receives and/or dispenses funds from/to the player.

In another example as shown in FIG. 3, the player interface component 104 may be configured for remote gaming settings such as internet-based games. For such gaming systems, the player interface component 104 may include a communication component 130 that provides a communication capability for remote gaming.

Various features associated with advertising on electronic game settings are now described. It will be understood that in various embodiments, the gaming system of the present disclosure can implement any of these features independently, or in any combination.

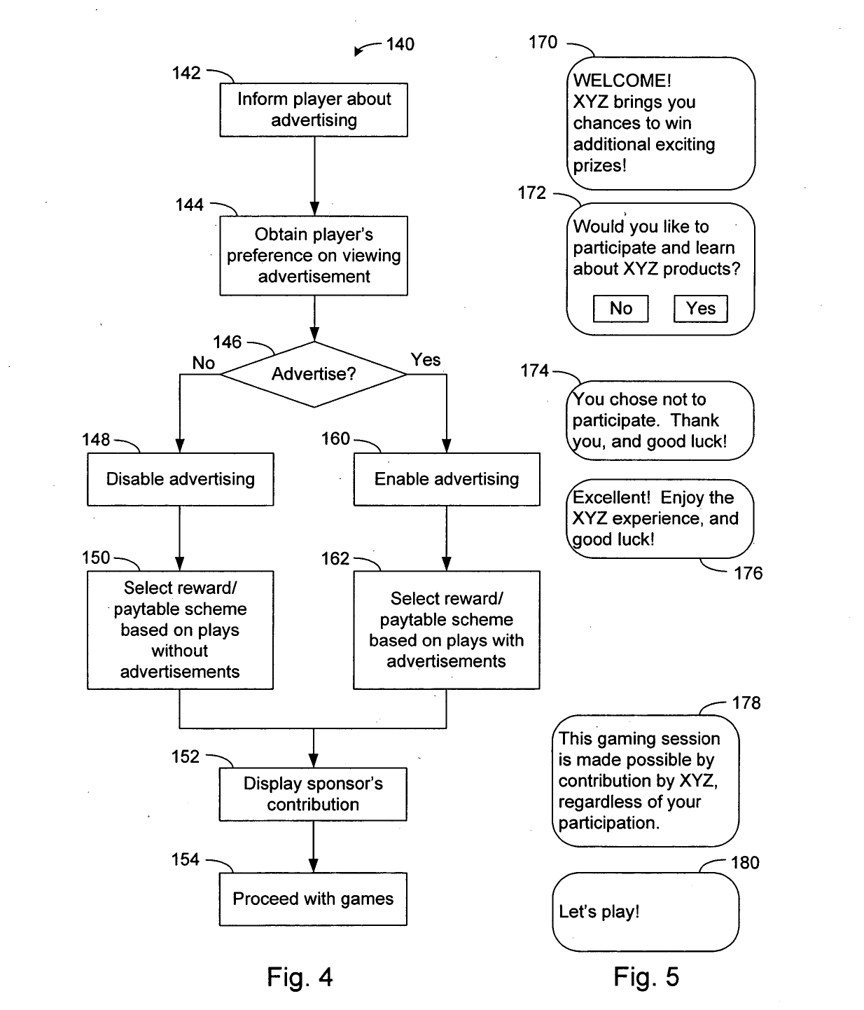

One embodiment of the present disclosure relates to advertising on electronic games based on the preference of the player. FIG. 4 shows one embodiment of a process 140 that can make advertising during electronic gaming more effective by providing players with at least some actual and/or sense of control. FIG. 5 shows examples of messages and/or input prompts that can correspond to the different process blocks of the process 140.

In a process block 142, the process 140 informs the player about advertisements that are available. An example message 170 can inform the player that an advertiser “XYZ” is sponsoring at least a portion of the operation of the game, and also that the player can win exciting prizes in addition to the game winnings.

For the purpose of description herein, a “prize” can include a reward, incentive, bonus, enhanced paytable, and the like, or any combination thereof.

In a process block 144, the process 140 obtains the player's preference on viewing of the available advertisements. An example message 172 can ask the player whether he or she would like to participate and learn about XYZ products. The player can then be prompted for an election by providing “Yes” and “No” options.

In a decision block 146, the process 140 determines whether to present advertisements to the player based on the player's election. If the answer is “No,” the process 140 in process block 148 disables advertising. An example message 174 can inform the player that he/she chose not to participate. The example message can also thank the player for playing the game, and wish him/her good luck. In a process block 150, the process 140 selects a reward/paytable scheme based on plays without advertisements.

If the answer in the decision block 146 is “Yes,” the process 140 in process block 160 enables advertising. An example message 176 can thank the player for electing to participate in advertising. The example message can also wish the player good luck. In a process 162, the process 140 selects a reward/paytable scheme based on plays with advertisements.

In one embodiment, the reward/paytable scheme for plays with advertisements can have payouts (for a given win) that are greater than that for plays without advertisements. Thus, such advertisement-dependent paytable scheme is an example of a functional link between the paytable and advertisement components described above in reference to FIG. 1.

In one embodiment, the process 140 in process block 152 informs the player of the advertisement sponsor's contribution to the operation of the game, whether or not the player elects to participate in the advertisement. An example message 178 can inform the player that the gaming session is made possible by contributions by XYZ, regardless of the player's participation.

In a process block 154, the process 140 proceeds with the game. An example message 180 such as “Let's play!” can be displayed to the player.

In one embodiment, the player makes an election to either participate or not participate at the beginning of a gaming session. In such a configuration, the paytables can be set for the duration of the gaming session, depending on the election.

In another embodiment, the player can make an election to either participate or not participate at various times during a gaming session. For example, an initial election can be made by a process similar to the process 140 described above in reference to FIG. 4.

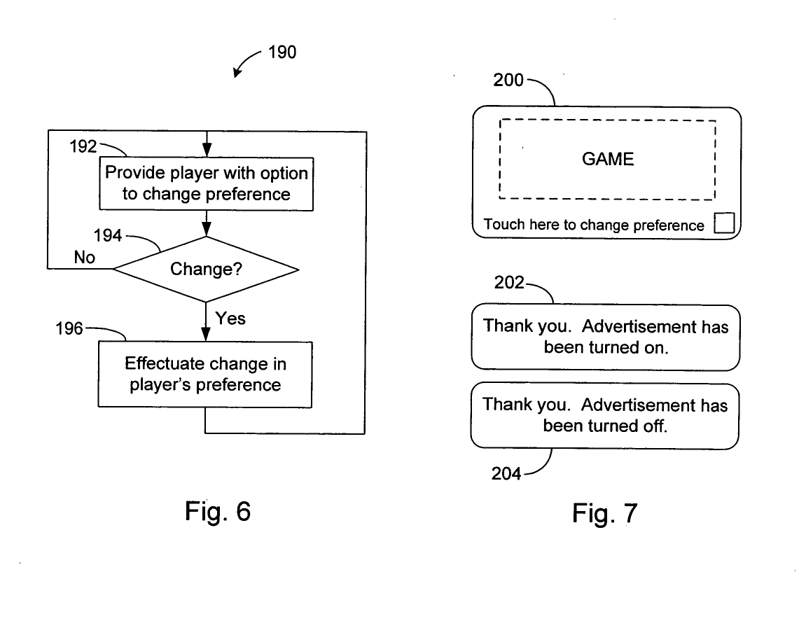

As shown in FIG. 6, a process 190 can be implemented to allow the player to change the advertisement preference during a gaming session. In a process block 192, the process 190 provides the player with an option to change the preference on advertisement. As shown in FIG. 7, an example message 200 can prompt the player to change the preference by, for example, touching a “change” button on the screen.

In a decision block 194, the process 190 determines whether a preference change has been activated by the player. For example, touching of the “change” button can activate the preference change. If the answer is “Yes,” the process 190 in process block 196 effectuates a change in the player's preference. In one embodiment, the change in preference toggles between participate and not-participate modes. An example message 202 can be displayed when the preference is toggled to “participate,” by informing the player that advertisement has been enabled. An example message 204 can be displayed when the preference is toggled to “not-participate,” by informing the player that advertisement has been disabled.

If the answer in the decision block 194 is “No,” the process 190 can be configured to loop back to the process block 192 to thereby provide the player with the option of changing the advertisement preference.

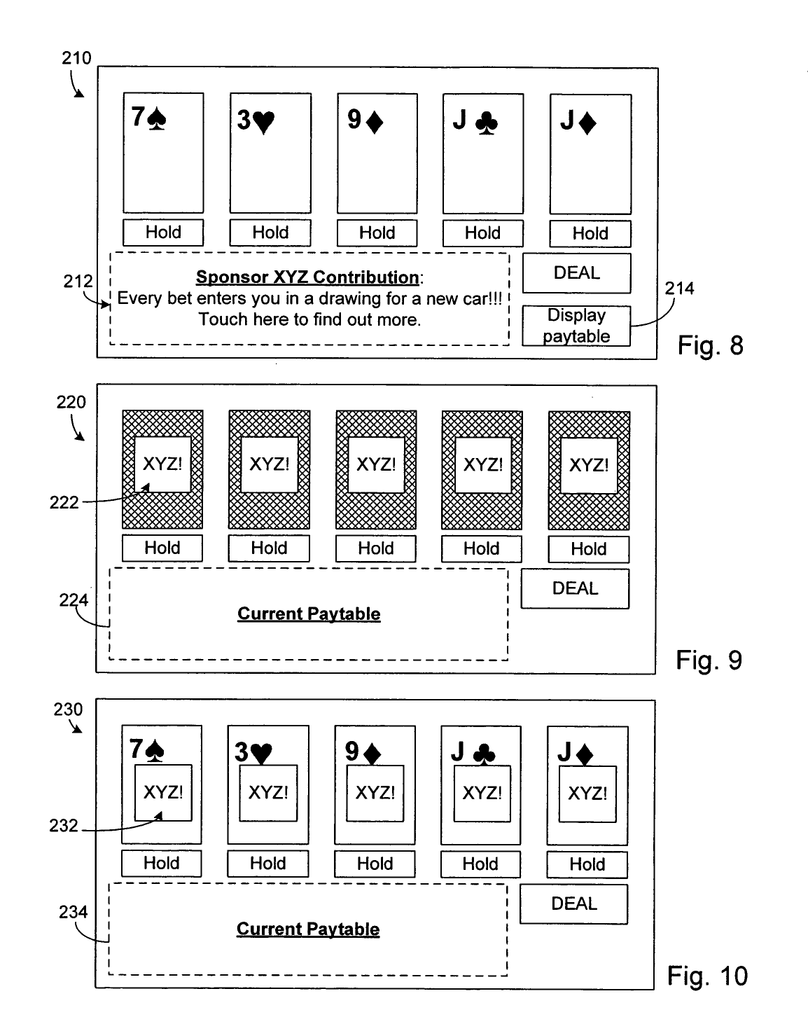

One embodiment of the present disclosure relates to various “locations” on the electronic game where advertisements can be presented. FIGS. 8-10 show different locations where advertisements can be presented in an example electronic card game setting. In one embodiment, such advertisements are presented to the player if the player elects to participate.

As shown in FIG. 8, an example gaming setting 210 depicts an example game of Five-Card Draw. An advertisement 212 is depicted as being presented at a space that is separate from the gaming visual representations such as playing cards. In the example game setting 210, an option 214 for displaying the current paytable can be provided to the player. Thus for the various embodiments where paytable changes with the player's election, different paytables can be displayed depending on the current state of the player preference.

As shown in FIG. 9, an example gaming setting 220 can include advertisements 222 displayed on the back side of the electronic cards. In one embodiment, an option (not shown, but similar to the option 214 in FIG. 8) for displaying the current paytable can be provided. In one embodiment, a current paytable 224 can be displayed concurrently with the gaming visuals.

As shown in FIG. 10, an example gaming setting 230 can include advertisements 232 displayed on the front faces of the electronic cards. In one embodiment, an option (not shown, but similar to the option 214 in FIG. 8) for displaying the current paytable can be provided. In one embodiment, a current paytable 234 can be displayed concurrently with the gaming visuals.

In one embodiment, the foregoing advertisement location examples can be combined in any manner. For example, advertisements can be presented at a location separate from the gaming visuals (such as cards), in conjunction with advertisements on either front or back of the cards.

One embodiment of the present disclosure relates to gaming based advertisements. Such a feature is an example of a functional link between the gaming and advertisement components described above in reference to FIG. 1.

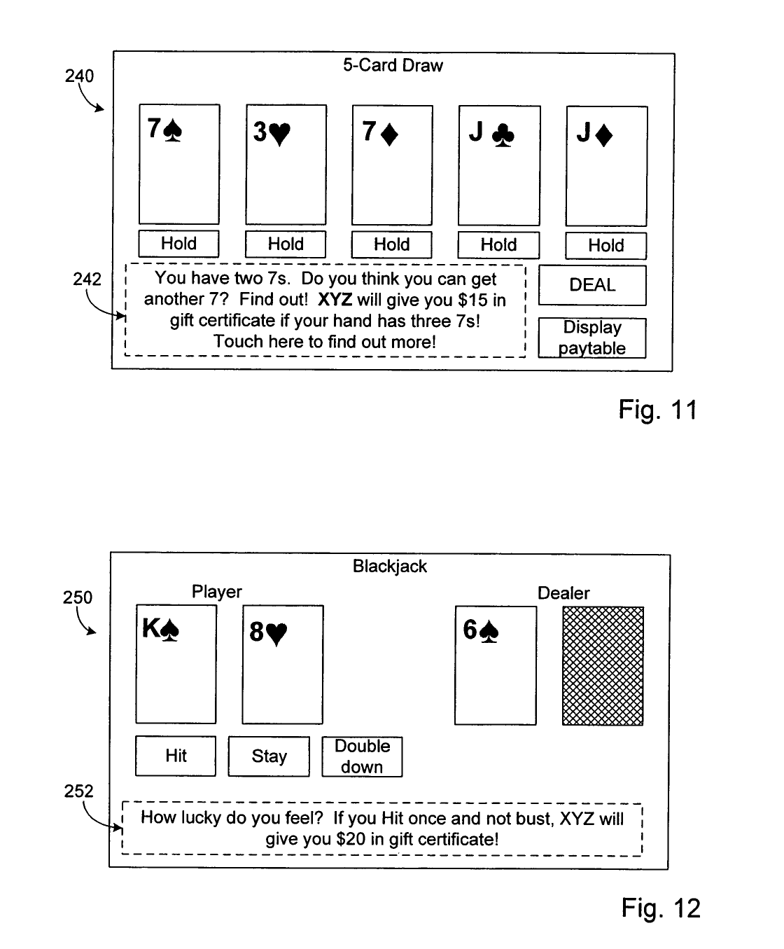

FIGS. 11 and 12 show by way of examples how advertisements can be tailored according to changing gaming situations. In an example Five-Card Draw game 240 of FIG. 11, an initially dealt hand is depicted as having two Sevens and two Jacks. Many players in such a situation may hold on to these two pairs, discard the fifth card, draw one card, and hope to form a full-house hand. In one embodiment, an advertisement 242 that is based on the current hand can be presented to the player. For example, the advertisement 242 can challenge the player to get a third Seven to win a prize. Thus, the player may think and decide whether to try to form a full-house hand (and thus win the corresponding payout), or likely forego the full-house hand to increase the chance of drawing that third Seven. The player may be further enticed by the fact that three Sevens will result in a payout from the game, as well as a prize courtesy of the sponsor XYZ. One can see that given such a decision making situation, along with information on the source of the challenge prize, the player will likely retain a greater impression of the sponsor XYZ than through a passive advertising.

FIG. 12 shows another example of advertising that is based on the gaming situation. In an example Blackjack game 250, the player is shown to have been dealt an “18,” with the dealer showing a “6.” Many players will assume that the dealer's hole card has a value of “10,” such that the likelihood of the dealer busting is great. Thus, many players will stay at “18.” In one embodiment, an advertisement 252 that is based on the current gaming situation can pose a challenge to the player. For example, the advertisement 252 can challenge the player to risk busting to hit for another card. If the player does not bust, then the player can win a prize courtesy of the sponsor XYZ. Thus, one can see that given such a decision making situation, along with information on the source of the challenge prize, the player will likely retain a greater impression of the sponsor XYZ than through a passive advertising.

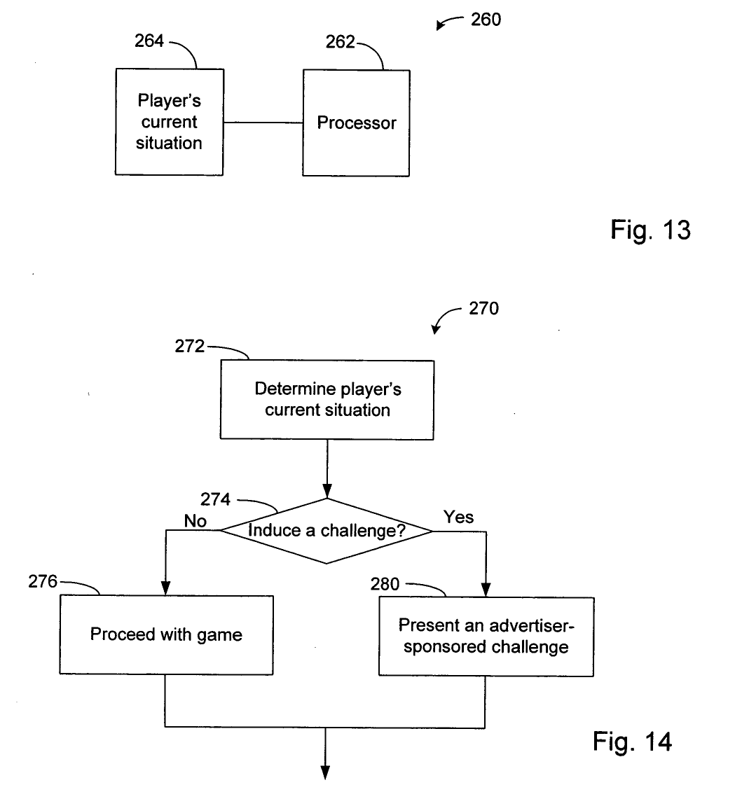

As one can see, such gaming based advertisements can be implemented in a number of different games. FIG. 13 shows a block diagram that depicts one embodiment 260 of such a gaming based advertisement. A processor 262 is shown to be functionally linked to the player's current situation 264.

FIG. 14 shows a process 270 that can be configured to advertise based on the player's current situation. In a process block 272, the player's current situation is determined. For example, the player's current hand (in card games) is determined. In a decision block 274, the process 270 determines whether to induce a challenge to the player, based on the player's current situation. If the answer is “No,” the game proceeds without the challenge in process block 276. If the answer is “Yes,” the process 270 presents an advertiser-sponsored challenge to the player based on the player's current situation.

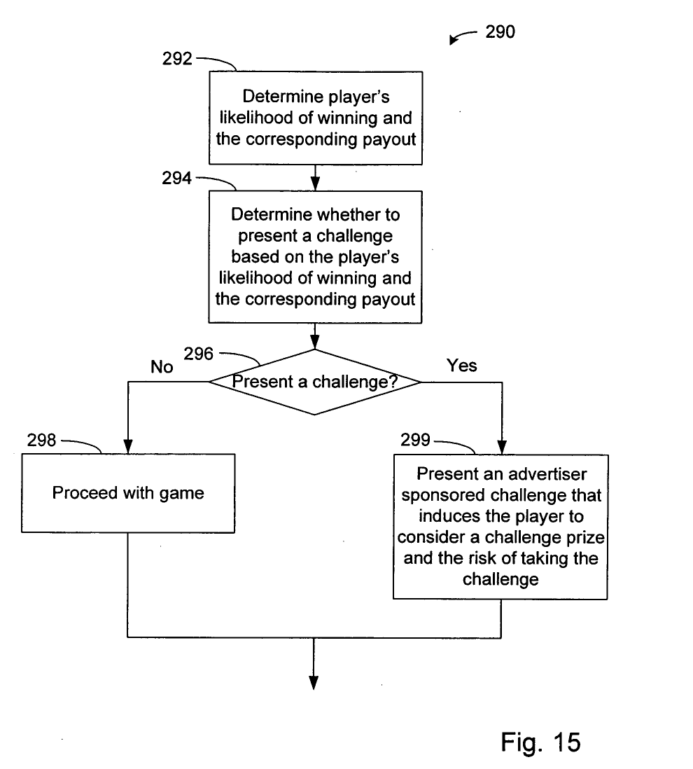

FIG. 15 shows a more specific process 290 that can be configured to advertise based on the player's current likelihood of winning and the corresponding payout. Such gaming parameters can be combined to form a value that can be used to determine whether to trigger an advertisement, and also to determine the value of the challenge prize. In a process block 292, the process 290 determines the player's likelihood of winning and the corresponding payout. In a process block 294, the process determines whether to present a challenge based on the player's likelihood of winning and the corresponding payout. In a decision block 296, the process 290 determines whether a challenge is to be presented. If the answer is “No,” the process 290 in process block 298 proceeds with the game. If the answer is “Yes,” the process 290 in process block 299 presents an advertiser-sponsored challenge that induces the player to consider the challenge prize and the risks involved in taking the challenge.

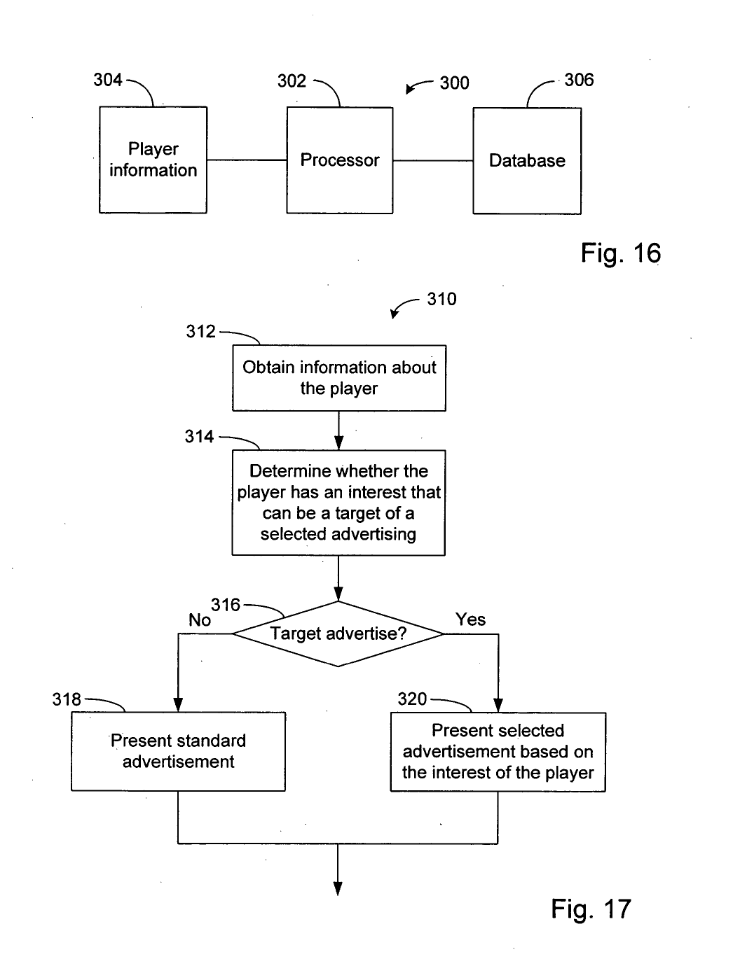

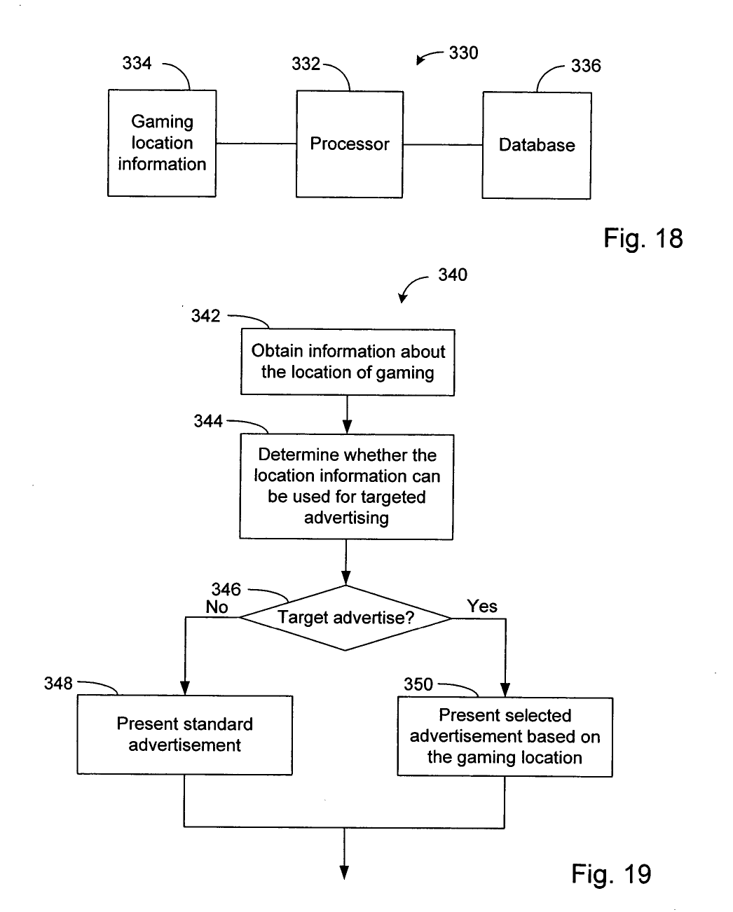

One embodiment of the present disclosure relates to targeted advertising during electronic gaming sessions. Examples of targeted advertising are described in context of player types (FIGS. 16 and 17) and gaming location (FIGS. 18 and 10). It will be understood, however, that other parameters can also be used for such advertising.

FIG. 16 shows a block diagram of one embodiment of a gaming system 300 configured to perform targeted advertising based on some aspect of the player. Thus, a component depicted as player information 304 is shown to be functionally linked to a processor 302. Player information 304 can be, for example, an electronic card (such as a gaming membership card) that identifies the player and possibly provide information about the player's preferences. For example, the card may contain information indicating that the player always wants to participate. The card may also include information indicating that the player prefers certain brands of products over other brands. Based on such information, the processor 302 can tailor the advertisements accordingly to thereby improve the effectiveness of advertising.

As further shown in FIG. 16, the gaming system 300 can also include a database 306 where information about the player can be stored. For example, if the player information 304 only contains the player's name, that player's preferences can be stored in the database 306. Such stored information can be retrieved by the processor to tailor the advertisements.

FIG. 17 shows one embodiment of a process 310 that can perform the targeted advertising described above in reference to FIG. 16. In a process block 312, the process 310 obtains information about the player. In a process block 314, the process 310 determines whether the player has an interest that can be a target for a selected advertising. In a decision block 316, the process 310 determines whether to target-advertise. If the answer is “No,” the process 310 in process block 318 can present “standard” advertisements (which may include no advertising). If the answer is “Yes,” the process 310 in process block 320 can present selected advertisements based on the interest of the player.

FIG. 18 shows a block diagram of one embodiment of a gaming system 330 configured to perform targeted advertising based on gaming location. Thus, a component depicted as gaming location information 334 is shown to be functionally linked to a processor 332. Gaming location can provide information such as demographics. For example, players' demographics may be different between Las Vegas and Atlantic City (in the case of online and wireless (e.g. cell phone) type gaming, between, say Hungary and Macau). Based on such information, the processor 332 can tailor the advertisements accordingly to thereby improve the effectiveness of advertising.

As further shown in FIG. 18, the gaming system 330 can also include a database 336 where information about the gaming location can be stored. For example, if a given gaming device is known to be in Las Vegas, the database 336 can be configured to provide types of advertisements suitable for that locality.

FIG. 19 shows one embodiment of a process 340 that can perform the targeted advertising described above in reference to FIG. 18. In a process block 342, the process 340 obtains information about the gaming location. In a process block 344, the process 340 determines whether the location information can be used for targeted advertising. In a decision block 346, the process 340 determines whether to target-advertise. If the answer is “No,” the process 340 in process block 348 can present “standard” advertisements (which may include no advertising). If the answer is “Yes,” the process 340 in process block 350 can present selected advertisements based on the gaming location.

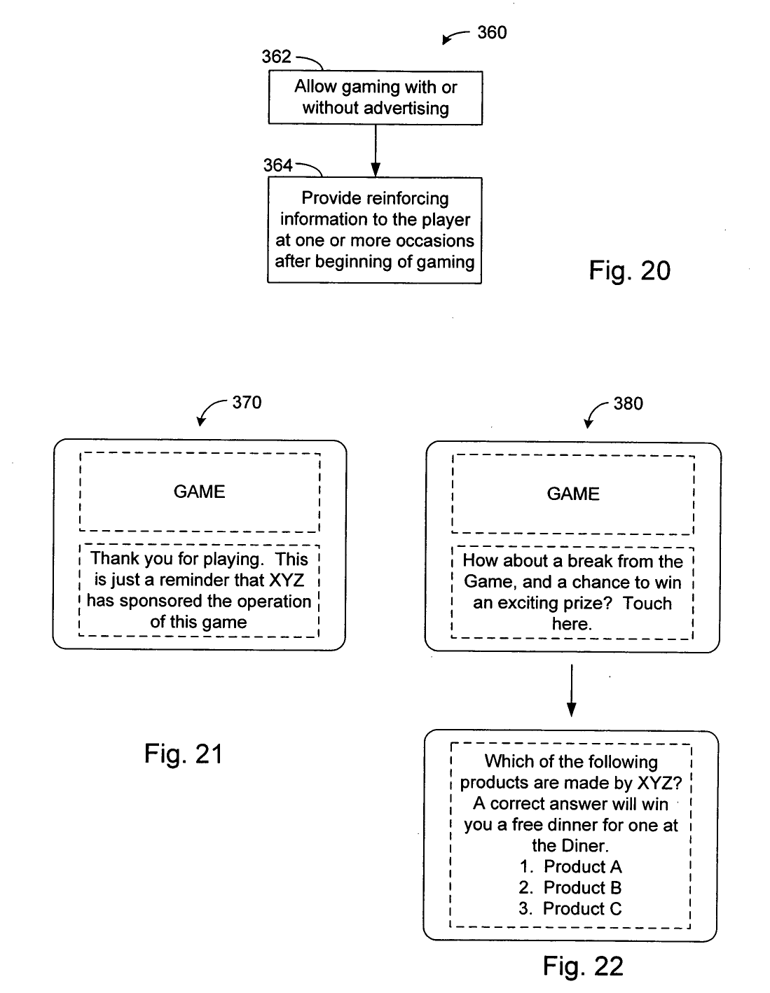

One embodiment of the present disclosure relates to a gaming system that can be configured to provide reinforcing information about the advertising sponsor to the player. FIG. 20 shows one embodiment of a process 360 that can provide such reinforcing information, and FIGS. 21 and 22 show example messages having such reinforcing information.

As shown in FIG. 20, the process 360 in process block 362 allows gaming to proceed with or without advertising. As described herein, the player's election can determine whether advertising is presented or not. In a process block 364, the process 360 provides reinforcing information to the player at one or more occasions during the gaming session.

FIG. 21 shows an example message 370 that can be presented to the player who has elected not to participate in advertising. The example message 370 may include a reminder that the current gaming session is sponsored by the sponsor XYZ, thereby informing the player of the positive role of XYZ in the player's enjoyment of the game.

FIG. 22 shows an example message 380 that can be presented to the player who has elected to participate in advertising. The example message 370 may include information and/or prompts that can result in the player thinking about the sponsor. For example, the player can be prompted to take a brief break from the game and also have a chance to win a prize sponsored by XYZ. If the player chooses to proceed further, a reinforcing message in the form of a statement or a question can be presented to the player. For example, a multiple choice question about the sponsor can be presented to the player, along with a prize. Because of the chance of winning the prize, the player will likely think more about the sponsor XYZ, thereby reinforcing that company's name and information in the player's mind.

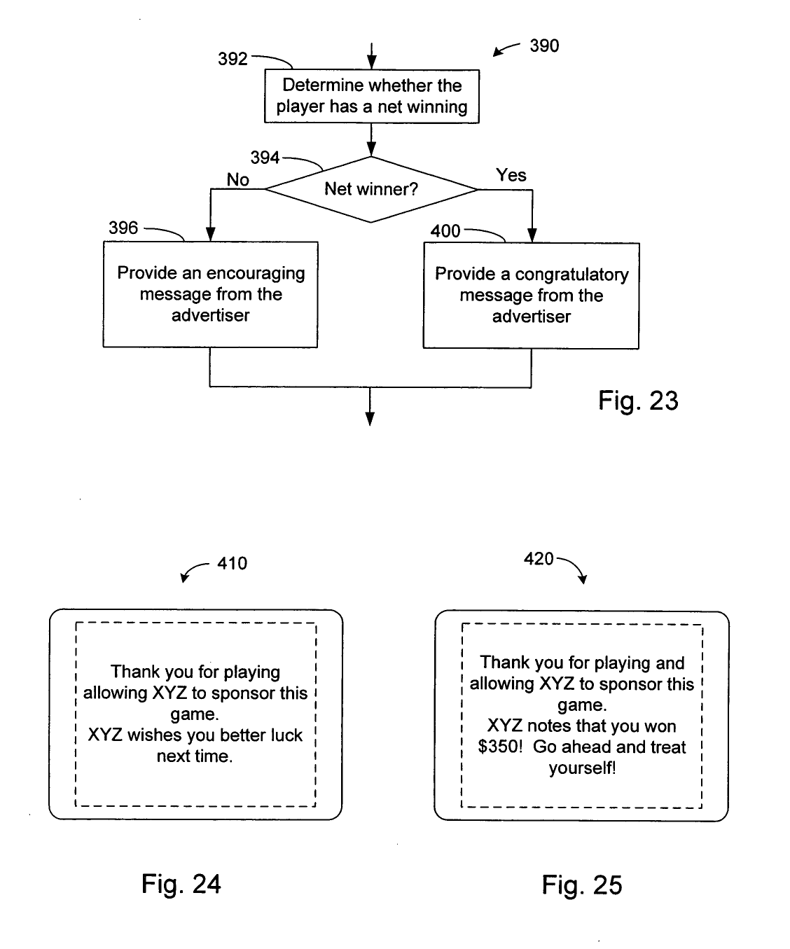

One embodiment of the present disclosure relates to a gaming system that can be configured to reduce the likelihood that a player will leave the gaming session with a negative feeling towards the sponsor. As is generally known, many players such as gamblers often have a negative association to the place and circumstances where he/she lost in gaming. Thus, a losing player may also have a negative impression of the advertisements and/or the sponsor. FIG. 23 shows one embodiment of a process 390 that can reduce the likelihood of a player leaving the gaming session with negative views of the advertisement and/or the sponsor. FIGS. 24 and 25 show example messages that can be presented to the player by the process 390.

As shown in FIG. 23, the process 390 in process block 392 determines whether the player has a net winning. In a decision block 394, the process 390 determines whether the player is a winner. If the answer is “No,” the process 390 in process block 396 provides an encouraging message from the advertiser. If the answer is “Yes,” the process 390 in process block 400 provides a congratulatory message from the advertiser.

FIG. 24 shows an example encouraging message 410 that can be provided to a player that has lost. The encouraging message 410 may thank the player for playing and for allowing XYZ to sponsor the gaming session. The encouraging message 410 may also wish the player better luck next time.

FIG. 25 shows an example congratulatory message 420 that can be provided to a winning player. The message 420 may thank the player for playing and for allowing XYZ to sponsor the gaming session. The message 420 may also remind the player how he/she won in the game and/or the advertisement-related prizes.

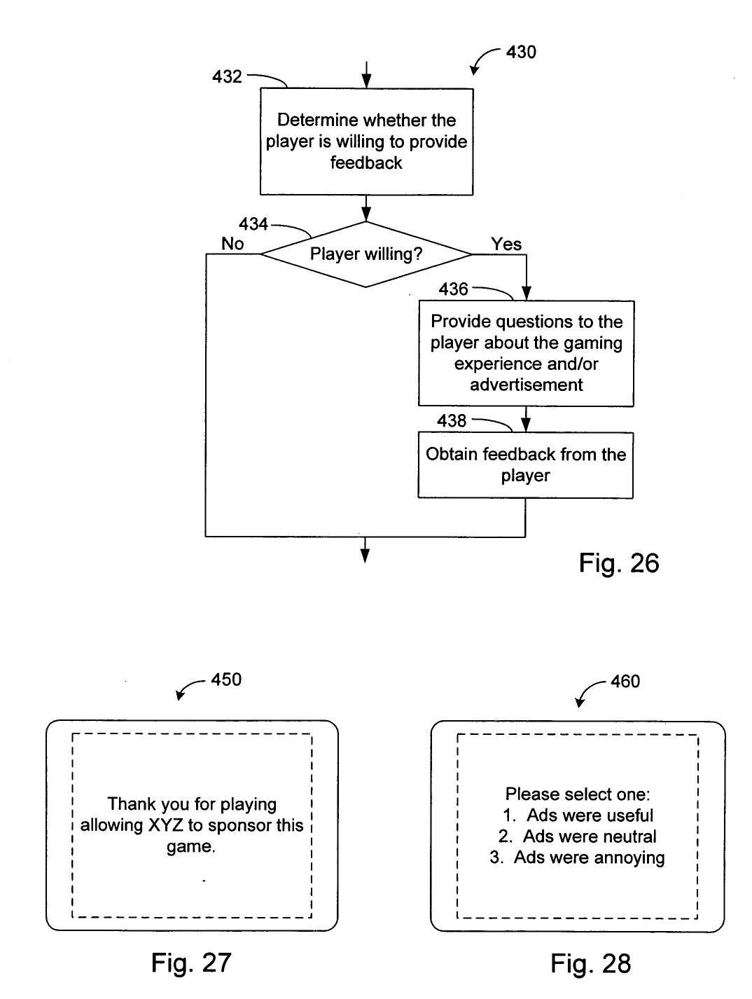

One embodiment of the present disclosure relates to a gaming system that can be configured to obtain feedback from the player. Such feedback can relate to the player's gaming experience and/or the advertisement experience. One can see that information obtained from such feedbacks can be useful for planning and marketing of games and/or advertisements. FIG. 26 shows one embodiment of a process 430 that can obtain feedback from a player during or after the gaming session. FIGS. 27 and 28 show example messages that can be presented to the player by the process 430.

As shown in FIG. 26, the process 430 in process block 432 determines whether the player is willing to provide feedback. In the decision block 434, the process 430 determines whether the player is willing. If the answer is “No,” then no further action is taken with respect to the feedback. If the answer is “Yes,” the process 430 in process block 436 provides questions to the player about his/her gaming experience and/or advertisement. In a process block 438, the process 430 obtains feedback information provided by the player.

FIG. 27 shows an example message 450 that can be provided to a player that chooses not to provide any feedback. The message 450 may thank the player for playing and for allowing XYZ to sponsor the gaming session.

FIG. 28 shows an example message 460 that can be provided to a player that is willing to provide feedback. The message 460 may be in the form of a question such as asking the player whether the advertisements were useful, neutral, or annoying. One can see that a collection of such answers can be useful in forming and/or presenting future advertisements.

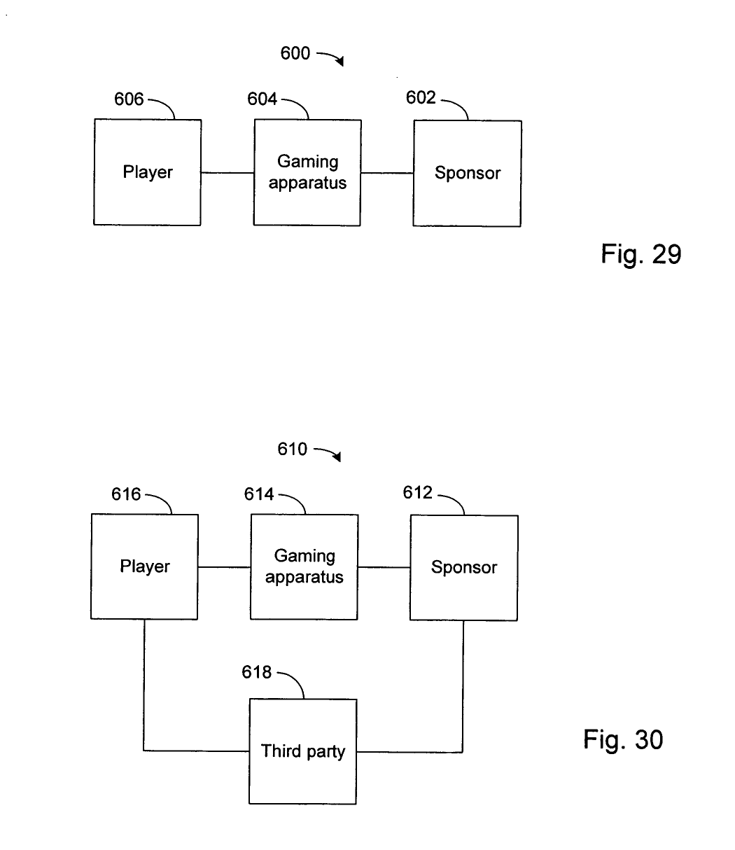

FIGS. 29 and 30 now show examples of how the various advertising and gaming relationships can be formed between different parties. FIG. 29 shows that in one embodiment 600, a sponsor 602 that sponsors the advertisements interacts with a player 606 via a gaming apparatus 604. Thus, prizes associated with the advertisements can be redeemed by or through the sponsor 602.

FIG. 30 shows that in one embodiment 610, a sponsor 612 that sponsors advertisements interacts with a player 616 via a gaming apparatus 614. A third party 618 is also shown to be involved. In one embodiment, prizes associated with the advertisements can be redeemed or honored by the third party 618.

In one embodiment, the third party 618 is a fulfillment entity that fulfills various advertisement related obligations and/or follow-ups. In one embodiment, the fulfillment entity may provide payments or redemptions of advertisement rewards. In one embodiment, the fulfillment entity may sell various goods and/or services that were advertised in the advertisement, either at market price or at various levels of discounts.

In one embodiment, the fulfillment entity is an actual establishment where the player can visit for redemption or purchase. In one embodiment, the fulfillment entity is a mail-based entity that redeems rewards or sells goods/services. In one embodiment, the fulfillment entity is a click-through ordering system for online-based gaming systems.

As described herein, a sponsor may be a company that wishes to advertise and interact directly with the player. A sponsor may also be an entity that represents one or more companies for the purpose of advertising.

As described herein, prizes associated with advertisements may be in any form, including but not limited to, a coupon, a token, a discount, or a voucher for a product or service displayed in the advertisement. As described above in reference to FIGS. 29 and 30, such prizes can be redeemed or honored by the sponsor and/or a third party.

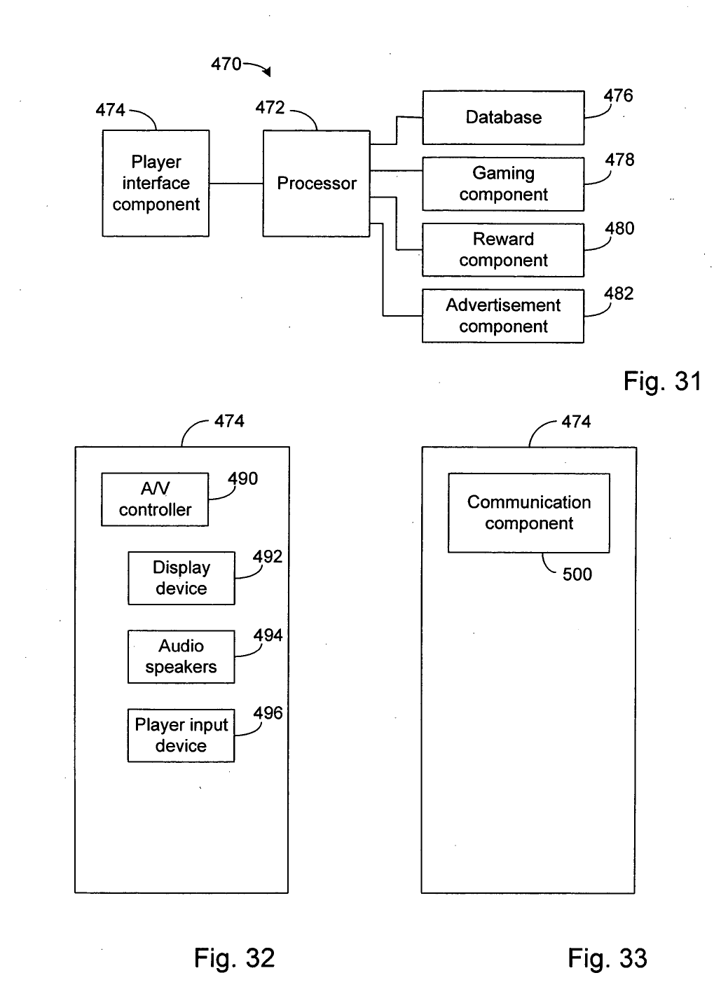

As described above in reference to FIG. 1, various advertisement features as described herein can also be implemented in non-gambling gaming settings. FIG. 31 shows a block diagram of one embodiment of a non-gambling gaming system 470 having a processor 472 that controls one or more features of the system 470.

As further shown in FIG. 31, a player interface component 474 can be controlled by the processor 472. The player interface component 474 can vary according to the type of games.

As further shown in FIG. 31, the gaming system 470 can also include a database 476 that stores information related to gaming and/or advertising.

As further shown in FIG. 31, the gaming system 470 can also include a gaming component 478 that facilitates the operation of the game(s) being played. In one embodiment, as described herein, at least some functional feature of the gaming component 478 can be linked to the advertising functionality of the gaming system 470.

As further shown in FIG. 31, the gaming system 470 can also include a reward component 480 that facilitates rewarding of a winning player. For example, a winning player of an arcade-type video game may be awarded with additional free game(s). In one embodiment, as described herein, at least some functional feature of the reward component 480 can be linked to the advertising functionality of the gaming system 470.

As further shown in FIG. 31, the gaming system 470 can also include an advertisement component 482 that facilitates one or more advertising features as described herein.

FIGS. 32 and 33 show that the player interface component 474 of the gaming system 470 can be configured in different ways. For example, in electronic arcade games, the player interface component 474 may include an audio-visual controller 490 that controls a display device 492 (video screen, for example), one or more audio speakers 494, and a device 496 joystick, for example) that allows inputs from the player.

In another example as shown in FIG. 33, the player interface component 474 may be configured for remote gaming settings such as internet-based games. For such gaming systems, the player interface component 474 may include a communication component 500 that provides a communication capability for remote gaming.

For the purpose of description herein, “non-gambling” can include gaming without wagering and/or playing to win where bonuses and enhancements in paytable and/or probability of win are subsidized by either the game operator and/or from income from advertisers.

In some embodiments, a non-gambling gaming system may be based on games that are traditionally gambling-related. For example, card games such as poker and blackjack are gambling games, especially when the player is required to place a wager to play.

In some situations, the advertising revenue may exceed the gambling revenue for the operator of a given gaming system. In such a situation, the operator and/or the advertising sponsor may decide to operate the system so that the player does not need to place a wager, or only needs to place a token wager to play the game. In one embodiment, the player is informed of the advertising nature of the gaming system he/she is about to play on, and permission can be obtained accordingly.

One can see that such no or low risk gaming enjoyment can attract many players who would otherwise not play. Furthermore, for gaming systems that do not involve player wagers, it may be possible to offer such systems to players at places or settings that are not allowed by a gambling regulation.

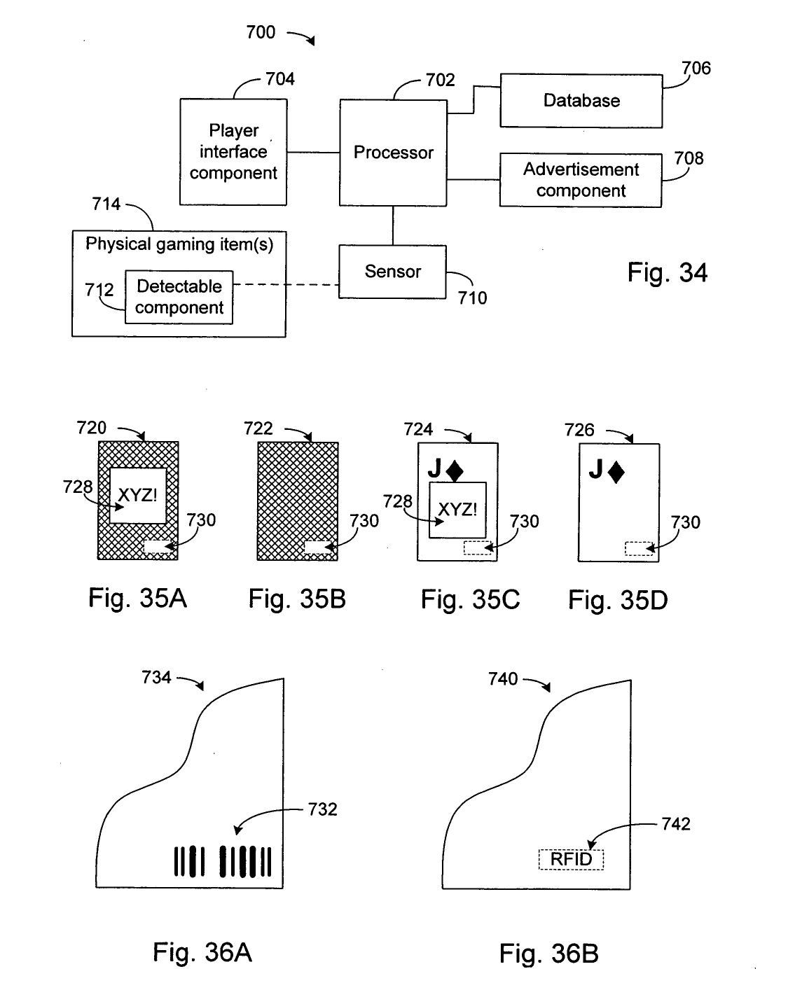

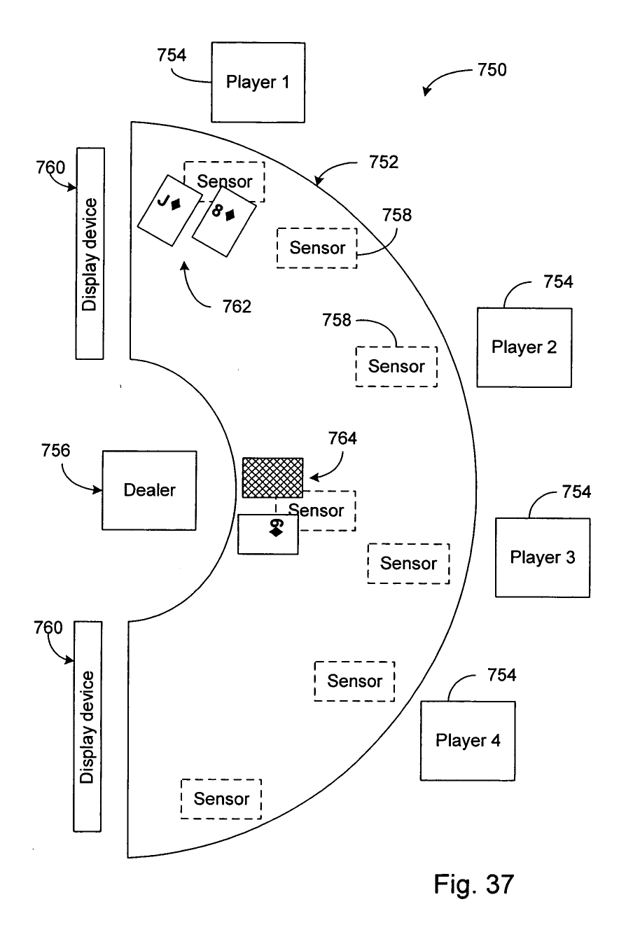

FIGS. 34-37 show that in some embodiments, various advertising techniques described herein can also be implemented in live gaming situations. FIG. 34 shows a functional block diagram of one embodiment of a live gaming situation. FIGS. 35A-35D show examples of physical gaming items, such as playing cards, that are configured to facilitate advertising in live gaming situations. FIGS. 36A and 36B show examples of detectable components that can be imbedded in the example cards so as to allow detection of information stored therein. FIG. 37 shows an example live gaming configured to facilitate various advertising features described herein.

As shown in FIG. 34, one embodiment of a gaming system 700 having a processor 702 that controls one or more features of the system 700. A player interface component 704 can be controlled by the processor 702. An example of the player interface component 704 is described below in greater detail.

As further shown in FIG. 34, the gaming system 700 can also include a database 706 that stores information related to gaming and/or advertising.

As further shown in FIG. 34, the gaming system 700 can also include an advertisement component 708 that facilitates one or more advertising features as described herein. The advertisement component 708 can also facilitate various advertising-related rewarding functionalities as described herein.

As further shown in FIG. 34, the gaming system 700 can also include one or more physical gaming items 714 having one or more detectable components 712. Each detectable component 712 can include information that facilitates gaming-related advertising. Examples of physical gaming items and detectable component are described below in greater detail.

As further shown in FIG. 34, the gaming system 700 can also include a sensor component 710 that can detect the detectable component 712 so as to provide the information stored in the corresponding gaming item 714 to the processor 702. The detection of the detectable component 712 may be achieved in any number of ways such as optically or electromagnetically.

FIGS. 35A-35D show various example configurations of an example gaming item. The gaming item is this example embodiment is a playing card having a detectable component 730 either inscribed on the surface or embedded. As shown, the playing card can have advertisements inscribed in various manners. In one embodiment 720, an advertisement 728 can be placed on the back of the card. In one embodiment, 722, the back of the card may not have any advertisement. In one embodiment 724, the advertisement 728 can be placed on the front of the card. In one embodiment, 726, the front of the card may not have any advertisement. In other embodiments, different combinations of the foregoing examples of advertisement placement are used.

FIGS. 36A and 36B show two examples of the detectable component 730 described above in reference to FIG. 35. As shown in FIG. 36A, one embodiment of a card 734 can have an optically detectable component such as a barcode 732. As shown in FIG. 36B, one embodiment of a card 740 can have a detectable component, such as an RFID tag 742, that can be detected electromagnetically. Use and detection of such detectable components are known.

FIG. 37 shows an example of a live gaming setting configured to allow implementation of the gaming based advertising described herein. A live blackjack gaming setting is used for the purpose of description. It will be understood, however, that many other forms of live gaming setting can also be configured in a similar manner.

As shown in FIG. 37, an example gaming system 750 includes a blackjack table 752 having places for one or more players 754. A dealer 756 deals the cards according to the applicable blackjack rule. The blackjack table 752 can be configured with one or more sensors 758 that can detect the detectable component in at least some of the cards.

As further shown in FIG. 37, one or more display devices 760 can be provided so as to allow viewing of advertisements and/or challenges, as described herein, by one or more players who are participating. In one embodiment, the display device(s) 760 may be visible to a player who is not participating, but that non-participating player is not presented with advertising-related challenges.

As further shown in FIG. 37, an example participating player (player 1) 754 is shown to have been dealt an “18” hand 762, with a dealer hand 764 showing a “6.” The sensor 758 can detect that the player's hand 762 is an “18” by sensing the card value information stored in the detectable component of each card. The sensor 758 can also detect that the dealer hand 764 has a “6” showing. Given such information, the processor 702 (FIG. 34) can generate a challenge to the player via the display component 760, for example, in a manner similar to that described above in reference to FIG. 12.

In general, a live gaming session is usually has an upbeat atmosphere, and players cheer each other. For example, when a player doubles down and wins, he/she is cheered on by fellow players. Thus, one can see that the foregoing gaming based advertising can add to the excitement of the game. When a challenge is presented to one player, other players can cheer on and encourage that player to take the challenge. When a challenge yields an advertising-related reward, other non-participating players may decide to join in on the excitement.

In one embodiment, the foregoing participation in advertising is based on permission of the player. Thus, each player that wants to participate may provide such permission in any number of ways. For example, the dealer 756 may provide an appropriate input to the gaming system to activate the permission-giving player's sensor. In another example, a player may have a membership card that provides an appropriate indication that he/she is willing to participate.

Some non-limiting examples of advantages and/or explanations of the various advertising features are now described.

In some embodiments, methods and systems are built around innovations in in-game advertising with features that are crafted from social science technologies referred to as theories of learning and motivational psychology. These result in psychologically and pedagogically augmented gaming and advertising. The principles and practices suggested by these fields are utilized to identify and create complementary, integrated, customizable functions that enhance player enthusiasm, actual win ratios and loyalty, and in so doing, casino/vending machine revenue models in multiple ways. Such principles include the values inherent in creating new revenue outcomes for players and operators from largely existing functions.

One embodiment is in the substitution of advertisements and marketing options where empty space or design characteristics are found on and around electronic playing cards and other reeling devices with visual display. This creates additional income from a source (e.g., advertising/marketing) other than or in addition to the players and machine operators. It also inverts a common gaming industry practice of paying for certain celebrity names and products that they believe to have currency with their patrons. This extra income can support several innovations in design, play, area economic stimulation and rich financial return to machine makers, designers and to participating casinos and patrons. It not only raises “positive expected value,” but also achieves other impelling variables in a major theoretically supported model of human motivation, namely the actual increase in the frequency of successful outcomes, in this case, in gaming.

This principle and space utilization is itself supported and amplified by several bracing options that are crafted to convert what may simply be an advertisement that is visible, or able to be seen, into one that alters intentionality so as to be seen or perceived, and sought for. This may be driven by another set of principles that could collectively be called personal empowerment. The embodiments utilized to achieve this conversion include, for example: opt-in gaming, or permission from players to have advertisements in their viewing field; consider alternate payouts that include tangible items and/or win-discount coupons on such; inducements to purchase such items irrespective of wins and losses; a delivery system that partners business with gaming operators and the potential for payoffs without risks of loss, or gaming without gambling.

These functions result in profit growth that is created from the development of new markets with broader demographics. This progression also is conducive to casinos to seek tie-ins with profit and non-profit institutions with educational and humanitarian goals since these organizations tend to have a devout following and are under increasing pressure to raise alternative streams of income and support. Together these systems convert conventional gaming's unappreciated value as compelling (and for many self-motivating) content into its re-emergence as a new media industry with an improved image and global outreach through its millions of screens with capacity to support game-integrated advertising and marketing both online and on land-based gaming devices and casinos.

Embodiments discussed herein allow the gaming industry to become part of the media industry at reduced or minimal costs and at some considerable advantages. The space found on, in and around electronic playing cards and other such video and related game graphics as are used in video gaming in casinos and online constitute a high visibility and high traffic area with global exposure. This space is ideally suited for advertising. Electronic cards and other such graphics resemble billboards. However, the advertisement space is smaller, though crisper and not over-weighted with land-based rental fees, installation and physical maintenance costs. It also is more visible for longer periods of close up and potentially intensive and vested interest viewing (e.g., it is seen and sought).

Generally, advertisement placement is satisfied to come into a visual or auditory field, and to the senses, and only incidentally to be seen with any significance. Some developments in advertising are focused on mechanical and (some would say puerile) attention getting devices such as raising the volume during advertisements, raising a banner advertisement on a computer or suspending the player's control over the game screen for several moments.

However, the goal and technology tapped in certain embodiments discussed herein are largely drawn from a different philosophical perspective and therefore a different set of technologies. They utilize tools and progress in the social science of pedagogy, and several subfields of psychology, such as cognitive, motivational and perceptual research on living organisms more so than machines. These technologies, for example, strongly suggest the value of reducing the negative and/or avoidance effects of facing a steep learning curve in order to engage a certain game.

Under these banners the goals become different than merely grabbing attention, although this is not discounted, to more like meeting deep and abiding human concerns that penetrate both extrinsic and intrinsic areas of motivation. In this way, the player becomes a seeker and a self-regulated participant more so than one to be manipulated and controlled. Accordingly, the space utilized is crafted, modified and made customizable so as to provide the goals of media advertising, such as more product information. The space utilized also provides more interactivity, individualization and loyalty building than either drive-by billboards or static magazine advertisements, and potentially more so than conventional radio and television advertising.

Advertisement space on both card games and other types of “slot machines” utilizing graphic displays (e.g., 3 lemons equals a win) is suitable everywhere conventional video representations, rotating graphics and video projection gaming may be found. Such games may also be played on modified vending machines that do not require gambling but retain the spirit of gaming and personal need fullfillment by exchanging a player's careful attention to certain advertisements for the opportunity to win designated products and product discounts paid for by some mix of the advertiser, manufacturer and/or the vending operator.

The strategic use of such advertisement placements and psychologically and pedagogically augmented gaming/advertising can increase revenue and flexibility in game creation and design. This reconciles principles of human engineering by influencing others with an inherently more democratic philosophy and practices intended to grant greater freedom and mutual benefits to players and all others who may come to be associated with its applications. Opportunity to extract such new revenue does not, in certain embodiments, impose significant new costs on players or operators. It is a new revenue stream with wide benefits. For example, a portion of the new advertisement revenue may be converted into increased payout incentives to players, higher profit margins to operators and a plethora of redesigned machines and offerings from machine manufacturers and related software developers.

Certain embodiments discussed herein also weave advertising features and new revenue into options that can add interesting wrinkles to many standard games and create a variety of new games and product prizes and discounts sponsored by advertisers and/or machine manufacturers, distributors and hosting casinos. Such embodiments encourage immediate prize pick-up thereby further increasing traffic to retailing areas both online and in local establishments. This creates increased “foot and viewing traffic, cash flows, product sales, repeat business, and related job and economic expansion.

Malls and markets have become destinations in and of themselves. They tend to generate sales from the exciting that they engender. One embodiment intentionally structures certain events and options so as to mimic and even enhance this effect by contiguously arranging the functions of product marketing and promotions with both online and land-based video and conventional table card gaming. The interactions of these will likely cause players to also make more actual purchases of desired products in this engineered environment of entertainment, excitement, ads, wins, pre-selection of rewards and related comparison shopping (and irrespective of whether players win or not, but more likely so if they win). This likely increase in actual sales amounts to a way in which casino operators can recapture some of their losses in the form of net profits from sales, and increased pricing of ads to producers and vendors based on such sales.

Permission advertising systems have broad application. The variation offered here includes options designed to seamlessly operate in tandem with the game, and typically featuring increased chances to win paid for by the supplemental permission advertising system. This combination of permission to see advertisements with value-added gaming can be implemented in many electronic formats in which a vendor offers a greater chance to win a prize and/or a deep discount or other such bonus in exchange for the potential buyer's attention to product information, pricing and purchase options.

Advertising and marketing value can be further enhanced by several optional systems and methods. Such systems have a variety of customizable values. For example, the addition of many of these can be designed to enrich advertising and brand loyalty by providing indications of the extent of the contribution of the advertisers and/or the machine maker and/or house operator to the enriched gaming experience.

The above systems also can be designed such that they provide extensive feedback on the attractiveness of various offerings and the extent to which advertising revenue is actually converting into distribution and new sales. This is of interest to advertisers. These systems can be extended to include regular playing cards that can be bar-coded or otherwise etched or printed alongside conventional advertisements placed on regular playing cards such that the bar codes could reveal possible wins of advertised products as well as of the sum bet, and potentially of prize wins with a hand that otherwise has not won the game being played. Operators and players are empowered to decide on the relative merits of playing out low percentage hands against the probability of winning some larger prize. Thus, gaming can be re-cast in a much better light that is educational, entrepreneurial and democratic.

A casino offered game of chance or competition has its fundamental gross and net income model based on modest but over time probabilistic advantages in the range of 0.5 to 2% over its players. To alter this advantage in the slightest way may be costly to the operator, or “house.” One of the ways in which casinos compete with one another is to offer and advertise the best percentage return to players as their costs and margins will allow. In this competitive environment, the infusion of new revenue into this equation can set in motion higher gross and net profits. New dollars can be infused into the gaming equation from the innovative use of a high traffic and high visibility space carefully utilized to sell advertisements and promotions as a new media outlet.

Placing such in-game advertisements any place and any where that games of chance are played amounts to creating a new media outlet with valuable revenue capability, just as in the advertisements that support broadcast television. These same advertisements can be presented in ways that are integrated to increase feelings of personal empowerment, increase “positive expected value” (a popular gaming term), but also raise expectations of success and individualization of success and actually increasing success ratios. In so doing, the system achieves many of the variables in modern equations on human motivation and action. This is the difference between a narrow and limited application notion, or relatively unhinged idea for an operationalizable principle.

Value added gaming is crafted so as to create several methods by which to increase a player's attention to, reinforcement for and stake in advertisements as well as to obliterate these should the player find them distracting or objectionable. This scientifically based set of subsystems address a variety of potential problems. One common problem is that a player could incidentally attach a negative attitude toward the product being advertised following a losing string. Value added gaming has several subsystems designed to optionally and operationally address several such negatives.

Value added gaming also can be applied to many gaming devices containing graphics. This can be applied to most all other possibilities involving gaming such as to regular playing cards. This can include conventional advertisements and/or bar coding on the cards since this allows for easier tracking and monitoring of wins and downloading payoff events into a computer server.

Advertisements can be targeted to the demographics associated with each game and situation with a particularly precise hit at some audiences where in this case there actually is a sellers' market, that is, more revenue available for advertising than space to satisfy it, as for example in the case of the tobacco and alcohol industries. These industries alone could well support this system as they are in global competition with one another. Targeting also can be extended to LAN based servers offering games such as solitaire for its constituency such as at a company or college with an audience that is particularly attractive to certain product advertisers.

There are several mechanisms to increase the opportunity for product purchase, such as by compatible systems as supported by the option to make a direct purchase through a hot-linked online vendor, or from nearby casinos and local vendor outlets with win receipts and/or printouts that could cover the full cost of the item or deep discounts.

Targeted advertisements increase each player's engaged and active viewing due to the enhanced likelihood of winning a few tangible and potentially pre-selected items. This is the case, for example, in gaming where the gaming business model is based on the principle that the players experience a net loss and/or make offsetting purchases at healthy profit margins in order for the business to operate at a profit.

In general, these systems-based benefits further increase player expenditures and reward such play with more varied and inclusive and easily portable prize options such as movie and music disks and watches. This amounts to a win for the “house,” a win for the advertiser, and a win for the player. There may be modest additional costs to the operator in securing advertisers directly or from a dedicated advertisement agency. In either case, cost-benefits ratios can be calculated with costs and pricing set to margins benefiting the operator.

New money creates several value-added options. For example, it can simply go to the “bottom line,” thereby increasing profit margins, and potentially enhancing the market value of the casino. It can be passed along to players thereby increasing player engagement and loyalty. This is likely to grow the business by increasing playing time and wagering due to greater monetary and/or personal value incentives to players, which then further increases revenue, cash flow and the market value of a business.

The likelihood of increased player investment in such gaming is supported by a host of psychological studies of human motivation. This harnesses the findings from motivational studies. Research shows, for example, that the traditional intermittent (hit amongst many misses) reward system used in many games may result in increased motivation to play when it results in: 1) increased wins (random and/or fixed ratio hits) by some noticeable factor (say approximately every 5^{th} X vs. every 9^{th} X); 2) when the extrinsic, or size, of the reward is increased (say from even money to 3×'s the amount played); and 3) when the reward system becomes internalized and/or supports some personal life goals (say in winning a deep discount or totally free product or service that is on one's wish list and/or tied to a matter of self-esteem and/or dire need such as a face lift in one case or a new appliance in another).

Achieving a variable but higher level of sustained gaming behavior has other benefits to players and operators. For the player it tends to increase familiarity with the task, lower new game/task related tensions and the perceived steepness of a new learning curve. Hence, it further increases the incentive value or enjoyment associated with simply doing the task (or playing the game). The game becomes self-rewarding as mastery, wins and strategies grow.

Such familiar and higher success routines also tend to further increase the incentive value of prizes since these become tangible and symbolic proof of a given win strategy. Symbols of success are like trophies in that they increase self-efficacy, or feelings of being competent and become a powerful way of raising self-esteem, a primary source of human motivation. Spoken differently, a prize becomes more valued, and likely to sustain efforts to achieve it when it is viewed as somewhat more achievable and a more frequent and likely occurrence. This motivational effect begins to plateau if the prizes are too freely won or too predictable. The challenge in gaming is to find a balance for play that simultaneously supports the business model, or operator profits as well as the player's investment and entertainment value. Where player cards and records can be kept of past play this balance can easily be offered in ways that can be customizable to individual players.

To restate and synthesize, embodiments discussed herein add value to operators, players, advertisers, machine makers and software developers. The increased revenue benefits to the game operators. Players benefit by the translation of this added revenue to players in the form of increased payouts, bonus prizes and ability to play longer and more personally fruitfully at modest additional cost. Benefits to advertisers include increase in branding, traffic and sales. Machine makers and software developers will have a whole new line of products to offer to an entire industry. Together these form synergies of additional benefits to each of these factors and to the economics of global gaming and to individual locales, virtual or brick and mortar where they are found.

Some embodiments include advertisements on regular playing cards. As mentioned above, regular playing cards may be bar-coded or otherwise etched or printed along with conventional advertisements placed on such that the bar codes (and associated bar code readers) can reveal possible wins of advertised products as well as of the sum bet, and potentially of prize wins with a hand that otherwise has not won the game being played. Operators and players can decide on the relative merits of playing out low percentage hands against the probability of winning some larger prize. The odds of winning larger designated prizes or discounts can be of far greater value than most other lottery type payouts. Hence while a player may reduce his/her risk of winning say a game of Blackjack by drawing another card, they may see some worthwhile benefit in drawing another card in order to qualify for, for example, three advertisements in one hand which may be a possible qualifier for an automobile. Such a player might also request an additional card to the allowable limit of a 21 count for the same reason should this information be bar-coded such that three of the same advertisements qualifies these cards to be scanned as possible winners of some larger prize. A player's club card can be used to store such win information and/or cumulative values for easy portability to a payout desk or to a designated vendor.

The extension of the gaming industry into something of a media industry is based on the increased revenue from advertising and promotions to gaming operators. New revenue can be monitored and where value models suggest converted to continued and/or development of new inducements to players in a variety of combinations (options—ⁿC) and permutations (order of options—ⁿP). For example, an operator's value model may be set into an algorithm or formula designed to indicate that the operator has achieved three additional increments of value from the supplementary advertisement income revenue source. In so doing, the operator's decision model may now permit up to three additional units of essentially new income to be re-invested in greater rewards to players. This would be done with the expectation that it would provide further inducements to continued play and/or to increases in the size of wagering. Incentives can be customized to player demographics.

Variations in the reinvestment of advertisement based revenues can include, for example, increasing the size of payouts to the player, improving odds of wining, and/or altering the nature of the game such that game strategy and goals are modified in response to some short term inducements. This is different from the “near miss” scenario in which a player is falsely led to believe that chances of a hit have improved even while the reward remains essentially the same. In this case, the player can weigh the relative value of losing his/her typical bet (e.g., $0.50-$2.00) since they are factually closer to a much larger criterion payoff than they would have been if they had no sevens. For example, there is likely to be an increased incentive value and therefore of risk behavior in response to some visual and/or auditory cue such as: “Win a watch if you show a pair of 7's before this offer disappears from the screen in approximately 7 minutes.” Or, “Three 7's equals a (large prize named) win, you have two.” The same can be done, perhaps more powerfully by offering something of personal value to the player as suggested by data from a survey of players, and/or by choices, actions or information derived from a particular player. In addition, players may be willing to specifically disclose what means the most to them as part of electing to see the advertisements under the permission advertising system option. Some formulas or algorithms can be designed to limit or greatly increase the number of very large prizes that can be awarded per period of time and numbers of plays. In some embodiments, this decision should not influence the random number generator, but merely the size and number of payoffs that the advertisers and/or the house may be willing to underwrite.

To reduce the likelihood of players negatively associating their losses with a particular advertiser (or the mis-linking of contiguous results), players in some embodiments are informed as to how much playing time has been underwritten by the advertisers: “You just played poker for 8 minutes and 14 games due to the contribution of XYZ, a participating advertiser.”

Improved operator margins allow more flexible business decisions, such as converting portions of increased income to greater incentives to players and hence to player satisfaction and therefore to both increased playing time immediately, and in positive anticipation of choosing to play again at the next available time. This is a goal of the gaming business since industry research and common sense suggest that customer satisfaction near equals customer loyalty, which is a prime ingredient in any business based on repeat business for sustainable profits. See the flow chart algebraically expressed below for a visual systems-based representation of the most basic additional benefits to both operator and player from such gaming as compared with conventional gaming alone. There also are significant benefits to game machine manufacturers, software writers, new game designers/makers as each of these will enjoy new business opportunities related to system and product upgrades.

TABLE I
Value-Added Gaming System Flow Chart

| | | | | | | |
|---|---|---|---|---|---|---|
| X = Conventional | + | Y − A = | + | ^{IC+IP}X + ^{(1+I) C}+ | → | Z^{IC+IPX+(1+I)C+(1+I)PY-A,} |
| gaming costs, | | Dollar Value- | | ^{(1+I)P}Y − A = | | Or, increased |
| payouts & gross/net | | Added to | | (or more | | Gross & Net |
| income with typical | | Gross & Net | | correctly, | | Income & hence |
| options as | | Income by | | yielding) | | Incentive Options |
| represented by: ¹C | | Value-Added | | | | and flexibility in |
| or current | | Gaming | | | | meeting market |
| Combinations & ¹P | | Systems, | | | | challenges as |
| as current | | minus slight | | | | represented by ^{(1+I)}C |
| Permutations on | | additional | | | | for enhanced |
| such Combinations. | | Costs, A. | | | | options and |
| Or,^{1C+P}X | | | | | | ^{(1+I)}P representing |
| | | | | | | increased |
| | | | | | | Permutations (or |
| | | | | | | rearrangements of |
| | | | | | | the order of the |
| | | | | | | options). |

There is a need in gaming to increase the revenue value of existing customers as an alternate way of increasing the number of customers since this has become relatively fixed at the level of males ranging from 18-45 years of age who also tend to be inveterate gamblers. Certain embodiments discussed herein are organized to answer this need in multiple and adaptive ways. Placing advertisements on actual playing cards is a practice that has not been supported to any substantial degree by more than occasional utilization, and very flaggingly so by the mid 20^{th} century. The beginning of the 21^{st} Century as seen some slightly more robust interest in this 3D option, probably due to an inflated interest in Poker on cable television. Electronic card games are not only available seven days a week, including all and varied holidays and therefore active as advertisements in, on or around the virtual cards around the clock, around the globe. Electronic advertisements can easily be set in as hotlinks with new age computer mark up languages, to product information and selected prizes and/or as direct purchases of related products or upgrades. From a promotional point of view, such playing and shopping can convert players from mere customers to fans of a product and related game; and particularly so for persons who are inveterate shoppers more so than gamblers. Some patrons of shopping will play to shop.

The various surfaces of an electronic playing card essentially can be viewed as able to be rotated and multi-functional mini-billboards with some of the same capacity for attracting attention and general visual interest as multi-colored neon signs on a darkened road. At the most simplistic level the back of the card is most inviting and least obtrusive, and therefore probably least visually interfering of the game. Nonetheless, the full face including, for example, along side or on a shared diagonal to the naming of the card and/or on the periphery of the front or back of an electronic card, also can be imprinted or styled with embedded advertisements and promotions. The same could be said of the field around the cards, it can be bathed in branded logos &/or slightly animated advertisements.

Games and advertisements can, in effect, be displayed in a conventional static manner, and/or with animations and sound or as an integrated and altering part of the game. Animations constitute one of several possible ways by which gaming machines could take fuller advantage of their computer-like capabilities/potential, more so than just mimicking old fashioned slot machines. Each new option also can be woven into the spirit and risk elements of the game. In some embodiments, the typical graphic elements of the game, including unused and background design features, are dynamically woven into the elements of gaming and risk assessment. For example, animated cheerleaders could appear touting the likelihood of a high-end branded watch whenever two of a necessary three sevens appear. Within the framework of such embodiments, this could cause players to increase their “positive expected value” and reasonably alter their draw in favor of an additional possible seven instead of discarding the small pair in favor of say a possible straight or flush.

In some embodiments, the cards themselves can be introduced and played to a pleasing sound either intentionally hypersonic (within a narrowed and targeted range) or loud enough for broadcast to a designated area. Such cards also can be set in motion, as for example by traveling to a portion of the screen designated for special prizes or bonus awards whenever these become more probabilistic. For example, as when four cards are suited and only one remains to be flipped for a possible flush hand that has been designated as meeting a win criterion. The cards also can be morphed into some pleasing graphic representation, such as panda bears with card designations on them. This routine may also be set up so that it would offer an option for making an additional and separate advertisement influenced bet, or splitting the regular game bet into two separate hands, as in Blackjack. In this case it can also involve options for drawing an additional card or two. House or specific game rules would apply.

The systems and methods discussed herein will likely act as a heuristic suggesting a multitude of possible ways by which to heighten the gaming experience, with limitations only of imaginative mixes of graphics, promotions and variations on yet uncharted game designs. For example, otherwise fixed reeling machines (where three of some object wins) do much more than banner a brand in such largely mechanical devices. The reel machine can also be retooled to look and function as a video display that simulates reeling or mechanical functions.

Variable payoff options can be expressed or conveyed in various ways. In a casino environment, or wherever vending machines may be employed to offer win/lose games, wins could be paid off by, for example, a printed numbered and perhaps bar coded minimal (say 10-15%) or deep discounted (25%+) coupon, or what might be called a numbered Receipt Of Win (ROW). The same could be accomplished by an electronic communication to a central server and prize pick-up center; and/or noted and confirmed by a casino/vending operator employee who might be dressed in some special and entertaining fashion, but may serve some important function such as entering a confirmation code. Players also could be issued small electronic devices or player cards that note the event and then can be downloaded into a computer that confirms wins and payoffs at a central location or in several locations with an appropriate console or at some system level, such as through a card reader which can be conveniently placed in each hotel room in a designated wide area network. Conveying such wins, and potential losses to a central computer terminal and receipt or ROWs' printer, can serve as proof of costs and income for taxation purposes for both land-based casinos and individual accounting. Similarly, this system can function on line, or through LAN based systems and localized servers, and/or by wireless transfer.

The above options may be offered to companies or large non-profits acceding to social entrepreneurial income streams from such play, advertisement viewing and potentially related sales. In such circumstances there could be, for example, a no gambling option with no risk of loss in playing, but yet the potential to win, hence qualifying as a “Positive Expected Value” in gaming parlance. Rewards, can be in the form of products and product discounts offered by brands and retailers who find value in doing so either to distribute sample product, draw-down excess inventory, and/or simply to aid familiarity and branding of their products or services. Clients may include, for example, educational institutions, foundations and government agencies (such as the DMV), where there is considerable wait time. The card Game Advertisements in such environments could serve as a choice icon or streaming advertisement on an Internet homepage or a screen saver and intentionally left to face out as a physical area mini-billboard to passers by when the computer terminal is not otherwise in use. This is a viable consideration since many firms and non-profits allow their employees to play such games for diversion during lunch and breaks, and other such down times.

A for profit firm with heavy foot traffic could find this supplementary income option appealing, with the likely exception of advertisements for a product that competes with their own. For example automobile clubs where license plates can be renewed and financial products are sold and people spend time waiting. This can be adapted and struck with non-profit institutions with advantageous foot and/or internet traffic in, for example, their bookstores and through dedicated links on their homepage. In this way institutions can share in the advertising revenue or simply contract to allow the games and product rewards as morale boosters to employees and to those they serve, such as: students and information seekers to a university's admission's office or its library research collections. Such functionality also can be profitably brought to the vending game environment, as discussed herein. Indeed, the system can be set up so as to optionally serve to share profits with some noble cause such as in aid to needy children and countries through established agencies and entities such as the G8 Summit.

Permission (or election) advertising is an innovation that can significantly alter the gaming environment and the range of the demographics reached as well as increasing the degree of participation of current players. The permission advertising system has broad application extending beyond gaming. The idea is to transparently offer players the privilege of choosing to see and consider advertisements as: informational; pre-selected prize options; aiding and supporting some charitable cause; and/or simply as a way to improve the probability of wining.

This system invites vendors to share power and influence with players over features of the game and gaming experience. A deeply “felt need” of human motivation is the desire for further empowerment. A well designed method or system that stirs this fundamental need can be translated into greater incentives to engage in a certain act or behavior. In this case the option and process of making elections, or choices, can be harnessed to serve several purposes, such as: to further engage and encourage all who play and many who previously have not or would not to do so; as well as to reach-out to those for whom gaming might lose some of its personal value were advertisements and promotions otherwise inserted without their explicit approval. This subsystem compensates players for tolerating advertisements, while converting some to fans of this innovation, and with little risk of losing those who might resent them. By way of further explanation, all players will not respond to external prompts and bonus offers, some in fact may be put off by such transparent attempts to manipulate their game strategies, viewing habits and routines.

In a related vein, the online gaming industry is becoming increasingly aware of “Banner Blindness:” the over use of pop-up advertisements has led to blind eye and quick click off without even consciously seeing the paid for advertisement. Further, online gaming conversion rates (money paid per advertisement and fees per gambling customer) are falling as the acquisition of hard-core gamblers levels off and fewer new markets (like females and elders) are not being enticed to online gaming to any significant extent.

The simple premise of this version of permission advertising is that players be given a greater stake in their experience, and that this can be achieved by offering them an option to elect to see advertisements and bonus possibilities or not. According to constructionist psychological views and research this choice option grants players greater agency or sense of personal control over these inducements and hence is likely to raise their responsiveness to informational advertisements when these appear as a choice condition, and/or where they can toggle on or off, exercising greater personal control whenever they feel that the advertisements are becoming a distraction from the pleasure of the game or may be acting as interference to the level of concentration that an individual feels necessary to play strategically.

Once experienced, the ability to alter the gaming environment can further increase a sense of control rather than being controlled. The option to be able to “change the channel” in itself is motivational of continuation and repetition of this activity. In other words, power is its own reward and will likely be exercised in the “On” direction by the resistant player as much as occasionally “Off” by the otherwise persuaded player if for no other reason than that they can.

There are several possible embodiments of this “toggle option” principle. The request for permission can be implicit by simply designating certain machines as being so dedicated: such as, “GameAds & Bonus Play.” It also can be a mode option elected by an on screen touch or click of a mouse or like device. It also may be predetermined and recorded on a player's card at a casino, or by a longer term choice of options in online gaming menu, and/or by a radio device, such as an RFID chip containing a pre-selected wish-list, which could then allow operators to allow patrons to carry over some type of point accumulation over a designated period of time.”

Permission to target may include a request from the operator for some information on the player that may help in validating identity or collecting and using demographic data that could inform offers and targeted advertisements, or it may be as explicit as asking for what possible prizes one might wish to play. The “house” may reward such information gathering with some perk or comp or additional chips/coins. Such knowledge becomes useful in assessing an individual's personal values and hence intrinsic motives so that these may become interpreted into prize options that “incentivize” continued play and advertisement viewing and risk taking.

Industry research links satisfaction to customer loyalty. In short, risk-reward incentives to the operator and to the player may be estimated from a variety of factors and indices in the fundamental equation that defines human motivation and are weighed against operator costs and benefits. Such factors might include: the cost for a prize item to a grantor (such as the advertiser) and/or to the game operator and balanced by its incentive value to players. This balance of cost to benefit can be calculated on a dollar equivalency basis. It also may consider the potential dollar increase value to the longer term business model as determined by players' records of gaming decisions and revenue flow from advertisements viewed, time spent in gaming, size of wagers, and actual purchases that may follow.

Two important and related variables in both advertising and gaming are time related: stickiness and longer-duration play. The longer one looks at an ad the greater its effect on buying. The longer one plays the greater the likelihood that the prevailing odds, which favor the house, will be reached. Such data are easily monitored and may be submitted and interpolated by appropriate software designed to inform the gaming device of which options to offer to the player and in what order. The offer to consider targeted advertisements may well keep players engaged for longer periods in a game or refreshed and ready to switch to other games. This can have the effect of slightly extending the duration of play, but it will help to overcome fatigue and boredom, and therefore to increase return visits. Extending the duration of engaged playing and advertisement viewing time also known as “stickiness” in online advertisement parlance, may occur since such actions create a pleasurable experience recently referred to as “flow”—a state in which people are so involved in an activity that little else matters. This is proffered based on the alignment of gaming with empirical findings on eight characteristics of “flow;” most especially: an increased sense of control and competence; a challenge that requires a felt level of skill; clear goals and feedback; and, focus on the immediate experience. Together these factors tend to create a self-stimulating interest in the task and for many special interests in contiguous merchandize offerings. Ironically, sustained playing can be a fundamental incentive to even greater sustained and repetitive viewing itself when properly presented and used as a reward for meeting win options (such as “make any 3 of a kind and you win an opportunity to play for additional prizes”).

This expectation is supported by a theory of learning called cognitive dissonance that in marketing terms says: that the incentive value of a reward tends to grow proportionally to the level of effort expended in order to achieve it; or that persons value what they have worked harder for more than what may have come too easily, even where the reward may otherwise be precisely the same. One explanation for this is particularly relevant to the gaming industry and in this case to permission advertising. The explanation is that the reward of viewing and playing has been elevated to a higher value by its symbolic representation of having achieved a personal strategic goal.

In some embodiments, games can be played with limited to absolutely no monetary risk to operators or to players, and with benefits to all. There are several layers of value added to the gaming equation for operators, players and even the economic well-being of participating communities and entire countries such as now are outfitting themselves to the financial opportunities implicit in global, Internet and casino gaming (e.g., California, Cyprus, Great Briton, Pakistan). This is both a top-down and a bottom-up routine that is postulated on the premise that whatever is good for business (top) becomes a trickle down to customers, and since consumer spending leads to business expansion, it becomes beneficial again to job creation and the overall economic picture.

This generative model typically needs something to get it started and something to keep it going during economic down cyclicals. In this case, it begins with a better idea that draws in advertising and marketing dollars that then become a new source of revenues to the gaming industry. It then ratchets down and up as it is axiomatic that business typically try to convert new income to greater customer loyalty, attraction of new customers, and hence to greater stability of cash flow, potential for further expansion and then ideally to higher net revenue. Hence, the system is fitted to and supportive of the fundamentals of free market economics, even as practiced on a limited basis in more controlled national economies such as Cuba and China.

Greater incentives to players can be aggregated and accumulated by the operator at low to no additional cost with the aid of supplementary income from the pre-sale of advertisements and promotions. These then can be used to finance and underwrite other income generating functions that further grow the entire business and local economic models. These business expansions may include but are not limited to several benefits to operators, players and vendor partners combining and cooperating to offer and to afford to purchase any combinations of at least the following: hotel enhancements such as room upgrades at higher net profit rates and uses of service options, e.g., clothes cleaning and massage; growth from repeat stays at hotels; increases in area transportation income; growth in participating products sale; and increased local, state and federal tax revenues from the increased cash flow. Further, it becomes feasible to offer gaming without gambling due to the offset of lost income from product advertisements and income. A sufficient return on investment from gaining “eyeballs” and product tryouts may justify allowing gaming without monetary risk to the player. The revenue stream and associated benefits of targeted customers viewing and playing for discounts and prizes of branded items, or new items is likely to be conducive to manufacturers to willingly risk large cash expenditures to establish brand choice more so than just product interest.

This no-risk betting option opens the door to a variety of gaming possibilities heretofore unacceptable. For example, children and parents might play games in set aside areas having advertisements for toys, collectables and educational prizes while at the same time becoming more informed about and inclined to purchase such items at first opportunity due to elevated interest, desire and opportunity. Opportunity can be enhanced as well by Casino consoles and online games that are “wired” and fed updates and even short duration informational videos and/or hot link presentations of models and choice options that entice and allow direct purchase, or to provide more modest free discount incentive certificates for purchase in the other ways. Such advertisements on card games, and other such gaming functions (e.g., reeling machines), may be especially valuable to manufacturers and sellers of large ticket items such as appliances and automobiles where a player can be enticed into carefully viewing, pre-selecting and specifying many of a product's/service's features that they wish to play for, while simultaneously viewing and considering many of a product's or service's defining features and sales promotions.

Before and/or pre-selecting and/or during and/or after shopping gaming function is a source of considerable entertainment value to inveterate shoppers, and to immediate and delayed sales where a product's value is presented in a longer and more detailed informational type presentation and/or one involving some exercise such as being able to view models, colors and proportions in various styles and shades of most everything from autos to clothing. This sequence also should greatly increase female and smart shopper participation in an industry that needs to widen its appeal and attract a more mixed audience that can sustain and even increase costs for marketing and increased rate of growth. This cycle can generate advertising revenue at many stages of the process, such as revenue from: advertisements viewed during pre-selections either at the playing console or at other locations (either for comparison shopping purposes &/or to select options within an exclusive offering); advertisements viewed and House percentage gains from actual gaming; and yet further revenue from revenue sharing models with the “pick-up” system described next. Each of these steps also is likely to increase “positive expected value” in players. Simply as a function of viewing and knowing that they are playing toward their own personal wish lists. This is another example of how a given casino might distinguish itself and turn players of most any game anywhere into fans of a certain casino or game.

Partnerships between game operators and various vendors, including a house's own offerings can increase destination tourism, and energetic traffic, tryout and sales of many products and services beyond the actual prize won. Gaming operators offering prizes as well as cash awards can convert this option to further income from vendors and branded items who, to the mutual advantage of the operator, the player and the vendor would be able to consummate the arrangement in ways that benefit all participants by making directly targeted, collateral and impulse purchases. The likelihood of impulse purchases would be very high since a goodly number of people picking up prize acquisitions also would have won some of the many dollars that casinos payout. In short, many more people in this environment as compared with a typical shopping mall crowd will make large purchases since proportionately they will feel more flush with cash and in an expansive mood.

Some embodiments allow gaming operators to be able to negotiate one or more of several post-play revenue streams from these relationships. For example, they could receive a straight percentage commission on gross purchases above and beyond the designated prize; they could acquire equity partnerships with vendor/distributors; and/or they could be owners of certain retail and prize distribution outlets. The equity acquisition route is most favorable since the equity interest can be resourced with funds from the initial arrangement that increased customer traffic and purchases to the physical or online site. This option also serves the interests of the vendor partner since their establishment would become a preferred provider to operators who will be able to drive increased traffic to a site that also returns owner profits.

Gaming operators can improve their image by advertising the fact that a certain percentage of each sale goes to an operator and/or customer designated charity or cause. The viability of this option can be valued against the numbers of people either physically driven to a play location or encouraged to use an online casino by a certain church group, fraternal organization or other such coalesced group. Further, there are hidden costs to the gaming industry in its coming role as a media enterprise. For example, a major global auto manufacturer has regulations in its governing rules that they can not be in any way shape or form tied in with gambling. Most companies would likely alter their rules of advertising to market conditions. Gaming can advance this goal by ingratiating itself with non-profit and educational institutions, and by offering more enticing and mainstream entertainment and risk behavior.

Win-prizes might include: “An X Dollar Shopping Spree in Our Mall” or on specific items, such as of women's or men's apparel. This along with a few pictorial or animated moments of enticing information on the product on the electronic game board could, again, act as powerful incentives to attract greater interest and gaming from females, who are an advertisement agency's prime targets since they are the most frequent and thrifty shoppers and buyers for entire families. Such highly tangible and personal value prizes could be fashioned to very special interests and demographic niches. These might include: a chance to win a year or more of college/trade school tuition for a designated youngster—a strong possible incentive for grandparents who are frequent, though low wagering but increasingly high return casino customers. The increased traffic in actual and virtual malls (where prizes also may be selected and direct mailed) have predictable value to increased sales, and to the economic well-being of brick and mortar stores and neighboring communities since there is tax sales and/or income tax collection associated with most all purchases, and may even be required on prize values. With this routine a gaming site not only becomes a media advertising site, but also a virtual or real marketplace for many products and services.

Not only are products seen and considered, and therefore open to further advertisement revenue income, but there also is a greatly increased likelihood of collateral or incidental sales of other products and services, and especially so where further incentives may be fashioned to the occasion. For example, a real or virtual vendor may offer further on the spot deep discounts on overstocked or closeout articles, or articles and service for which its supplier may find it beneficial to be placed in a certain demographic of customer's hands at a certain low volume time. Such incentives can be customized to support otherwise weaker selling products and services, at low volume times, such as, e.g., “Available a 50% Discount is on Hair Styling at between 8-10 AM.” These also can be as creative as: “25% Discount on Tax Preparation—Did you know that your next visit could be partially Tax deductible if it includes a need to meet your tax preparer?” Or, “You have won a 25% Discount on dinner for two and cab fare to XYZ just 15 minutes from your hotel.”

Gaming, shopping, marketing and participating businesses and local economies are enriched by the gaming systems and methods discussed herein. These systems and methods can be enriched with software systems that track prizes actually claimed and additional sales this action may have stimulated. Hence these systems and methods can be customized into a monitoring and feedback loop for informational value to operators, advertisers, machine designers, and operator-vendor reward retail and delivery partners. Opportunity to collect such metrics on actual sales and product distribution is an objective and additional cost factor to advertisers. The additional costs with the above indicated systems and methods would be minimal and seamless. Also, these systems and methods can improve the image of the gaming industry as it serves to help achieve G8 nation goals by distributing some of its new wealth to local economies. This is economically more uplifting and efficient than collecting tax from gaming and then trying to re-distribute it to those in need. American Indian gaming and poorer out of the way destinations, such as Crete and larger ones such as Pakistan and Hungary have demonstrable interest in achieving such goal.

There are three functions drawn from instructional research that can apply nicely to informational advertising. They are identified here as: Pre-selection; Guided Decision-making; and Post-Exposure Consolidation.

Pre-Selection: Embodiment of Phase I of Informational Advertising. In this step the client player of most any game would be offered the option to pre-select what they wish to play for, or simply choose to play for what is offered. This step ideally would include a brief infomercial in written, audio and/or visual form. The player would further be encouraged to identify preferred product options such as flavor, colors, model, etc.

Guided Decision-Making: Embodiment of Phase II of Informational Advertising. In this step the player, or players where the game is competitive between dyads or among members of a collective group, would periodically be offered explicit or implicit choices or need to make strategic decisions that might alter end-game outcomes in order to, for example, achieve more immediate goals or some alternate outcome to the game. This could vary from risk of losing the game to something more like venturing to win by a certain narrower or greater than usual margin. Again, the example of a criterion of drawing three sevens illustrates this point in conventional poker. A player may be dealt a pair of sevens and a pair of Jacks and one disconnected card. In this case, the conventional choice would be to draw one card and to try for a full house, but with a 50% discount purchase on a pre-selected motor car as the offering for three sevens, the player might more likely choose to forgo a chance to win the hand with two pairs and/or even the extra reward of a full house by surrendering the pair of Jacks and drawing three cards with the lowly chance of drawing three sevens, or more.

Post-Exposure Consolidation: Embodiment of Phase III of Informational Advertising. In this step, which can take many different forms, the goal is to crystallize some critical aspects of understanding that will likely become internalized as a new learning and potentially as self-guidance in recalling and selecting the advertised brand. For example, the infomercial might be a jingle or inscription that says and portrays the significance of a soda brand's advertisement claiming that its “flavors are ubiquitous.” In this case there could be a quick post-exposure question on a screen or numbered question sheet that reads something like: “Brand X's ubiquitous flavor means that it: a) tastes like more than one flavor; b) is available everywhere you go; c) seems to be everywhere in mouth, nose and mind.” Repeated exposures to such a fine distinction should have the same effect as does another scientifically supported post-reading pedagogical tool called repeated reading. With each exposure the player would grow more fluent in reading such advertisements, insightful of their full or figurative meanings and quicker and more skillful at responding to such informational advertising questions in a fast paced, multi-leveled game environment.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Consequently, the scope of the invention should not be limited to the foregoing description, but should be defined by the appended claims.

What is claimed is:

1. A method for increasing odds of awarding prizes, the method comprising:
providing an electronic gaming apparatus configured to award a prize to a user according to a paytable;
accessing user preference data to determine whether the user prefers to view advertising;
displaying an advertisement on the electronic gaming apparatus in response to determination that the user prefers to view advertising; and
adjusting the paytable so as to increase the odds of awarding the prize to the user in response to determination that the user prefers to view advertising.

2. The method of claim 1, wherein the electronic gaming apparatus comprises electronic playing cards.

3. The method of claim 2, wherein the advertisement is displayed on the electronic playing cards.

4. The method of claim 1, wherein the electronic gaming apparatus comprises an online video game.

5. The method of claim 1, wherein accessing user preference data comprises providing a prompt to the user to decide whether or not to view advertising.

6. The method of claim 5, wherein the prompt for the user preference is provided at the beginning of a gaming session.

7. The method of claim 5, wherein the prompt for the user preference is provided to the user during the gaming session.

8. The method of claim 1, wherein the content of the advertisement is at least in part determined by a gaming situation encountered by the user.

9. The method of claim 1, further comprising displaying targeted advertisements based on information about the user or the gaming apparatus.

10. The method of claim 9, wherein the information comprises consumer interests of the user.

11. The method of claim 9, wherein the information comprises location of the gaming apparatus.

12. The method of claim 1, further comprising providing reinforcing information to the user about an entity that sponsors the advertisement.

13. The method of claim 1, further comprising providing a message to the user to reduce the likelihood that the user will have a negative impression about the advertisement.

14. The method of claim 1, further comprising prompting the user for a feedback on the user's impression of the advertisement.

15. The method of claim 1, wherein the prize comprises a coupon, a token, a discount, or a voucher for a product or service displayed in the advertisement.

16. The method of claim 1, wherein accessing user preference data comprises accessing data on a membership card of the user.

17. The method of claim 1, wherein the electronic gaming apparatus comprises a sensor configured to detect information contained in a detectable component in one or more physical playing cards used in live gaming, wherein the displaying the advertisement is based on the detected information.

18. The method of claim 17, wherein the detectable component comprises a barcode imprinted on one or more of the physical playing cards.

19. The method of claim 17, wherein the detectable component comprises an RFID tag embedded in one or more of the physical playing cards.

20. The method of claim 1, further comprising providing a reward or incentive for viewing of the advertisement.

21. The method of claim 20, wherein the reward or incentive is fulfilled by a third party.

22. The method of claim 1, further comprising receiving a wager from the user for a chance to win the prize.

23. The method of claim 1, wherein at least some of the prize is provided by a sponsor of the advertisement.

24. The method of claim 23, wherein substantially all of the prize is provided by the sponsor.

25. The system of claim 24, wherein the prize is provided from an advertising revenue provided by the sponsor.

26. A system for advertising, comprising:
an electronic gaming apparatus configured so as to award a prize to a user according to a paytable;
an interface component configured so as to access user preference data to determine whether the user prefers to view advertising;
a display component configured so as to allow viewing of an advertisement in response to determination that the user prefers to view advertising; and
a processor configured so as to adjust the paytable so as to increase the odds of awarding the prize to the user in response to determination that the user prefers to view advertising.

27. The system of claim 26, wherein the electronic gaming apparatus comprises electronic playing cards.

28. The system of claim 27, wherein the advertisement is displayed on the electronic playing cards.

29. The system of claim 26, wherein the electronic gaming apparatus comprises an online video game.

30. The system of claim 26, wherein the interface component accesses the user preference data by providing a prompt to the user to decide whether or not to view advertising.

31. The system of claim 30, wherein the prompt for the user preference is provided at the beginning of a gaming session.

32. The system of claim 30, wherein the prompt for the user preference is provided to the user during the gaming session.

33. The system of claim 26, wherein the content of the advertisement is at least in part determined by a gaming situation encountered by the user.

34. The system of claim 26, wherein the advertisement comprises a targeted advertisement that is based on information about the user or the gaming apparatus.

35. The system of claim 34, wherein the information comprises consumer interests of the user.

36. The system of claim 34, wherein the information comprises location of the gaming apparatus.

37. The system of claim 26, wherein the advertisement comprises reinforcing information provided to the user about an entity that sponsors the advertisement.

38. The system of claim 26, wherein the advertisement comprises a message provided to the user so as to reduce the likelihood that the user will have a negative impression about the advertisement.

39. The system of claim 26, wherein the advertisement comprises a feedback component configured to obtain the user's impression of the advertisement.

40. The system of claim 26, wherein the prize comprises a coupon, a token, a discount, or a voucher for a product or service displayed in the advertisement.

41. The system of claim 26, wherein the user preference data comprises data on a membership card of the user.

42. The system of claim 26, wherein the electronic gaming apparatus comprises a sensor configured to detect information contained in a detectable component in one or more physical playing cards used in live gaming, wherein the displaying the advertisement is based on the detected information.

43. The system of claim 42, wherein the detectable component comprises a barcode imprinted on one or more of the physical playing cards.

44. The system of claim 42, wherein the detectable component comprises an RFID tag embedded in one or more of the physical playing cards.

45. The system of claim 26, further comprising a reward or incentive provided to the user for viewing of the advertisement.

46. The system of claim 45, further comprising a third party that fulfills the reward or incentive.

47. The system of claim 26, further comprising a wager receiving component configured to receive a wager from the user for a chance to win the prize.

48. The system of claim 26, wherein at least some of the prize is provided by a sponsor of the advertisement.

49. The system of claim 48, wherein substantially all of the prize is provided by the sponsor.

50. The system of claim 49, wherein the prize is provided from an advertising revenue provided by the sponsor.
